(19) United States
(12) Patent Application Publication
(10) Pub. No.: US 2024/0071393 A1
(43) Pub. Date: Feb. 29, 2024

(54) METHODS AND DEVICES FOR IDENTIFYING A SPEAKER

(71) Applicant: ID R&D INC., New York, NY (US)

(72) Inventors: Konstantin Konstantinovich SIMONCHIK, New York, NY (US); Rostislav Nikolaevich MAKAROV, Barcelona (ES)

(73) Assignee: ID R&D INC., New York, NY (US)

(21) Appl. No.: 17/892,523

(22) Filed: Aug. 22, 2022

(51) Int. Cl. G10L 17/18; G10L 17/02; G10L 17/06

(52) U.S. Cl. CPC G10L 17/18; G10L 17/02; G10L 17/06

(57) ABSTRACT

Methods and devices identify a speaker by extracting speech features from at least one keyword. A speaker vector is produced by feeding the extracted speech features to a pre-trained neural network. The pre-trained neural network includes a convolutional neural network. The convolutional neural network serves as a backbone and provides a backbone embedding. The pre-trained neural network also includes a neural subnetwork. The produced speaker vector is compared with at least one of registered speaker vectors corresponding to known speakers to identify the speaker.

### FIELD OF THE INVENTION

The present invention generally relates to speaker identification systems based on voice biometrics, and more particularly to a speech-processing devices and corresponding methods for identifying a speaker.

### BACKGROUND OF THE INVENTION

For human being voice is the most natural method to share their thoughts and information to each other. A human voice or speech signal as naturally produced by acoustically exciting cavities of a human mouth and a human nose contains required information about an individual or speaker.

Speaker recognition is a biometric modality that uses underlying speech information to determine the identity of a speaker. Speaker recognition is employed for a wide range of applications such as in banking over a telephone network, voice dialing, voice mail, database access services, telephone shopping, security control for confidential information, remote access to computers or other electronic devices, forensic tests, and information and reservation services.

The application of speaker recognition can be divided into two parts: speaker identification and speaker verification. Speaker identification is to determine the identity of an unknown speaker based on the speaker's speech utterances, whereas speaker verification is to use the voice to verify a certain identity claimed by the speaker. Recognition of speakers is done based on text-dependent and text-independent speech samples. Meanwhile, the identification without constraints on the speech content represents the text-independent identification system, whereas the text-dependent identification system requires speakers saying exactly the same utterance, in particular predefined password or passphrase. For example, typical passphrases in text-dependent identification systems may be wake-up words used for smart speakers, such as “Alexa”, “Ok Google”, “Hey Siri”, etc., or short utterances like “Verify my voice”, “My voice is my password”, etc. In other words, text-dependent voice biometrics is a way to authenticate a voice by prompting a user to speak a predefined passphrase.

Currently, there exist many well-performing speaker recognition systems based on GMMs, Dynamic Time Warping, deep neural networks, etc. Most voice biometric text-dependent verification systems are currently based on the so-called “x-vector” approach. This approach utilizes a deep neural network that takes specific speech features or a raw speech signal and returns a vector (an embedding which is called “x-vector”) that represents characteristics of the speaker's voice.

However, most of the advanced voice biometric text-dependent verification systems are based on residual neural networks, i.e. ResNet-type neural networks based on residual blocks grouped in stages. It is to note that Residual neural networks utilize skip connections, or shortcuts to jump over some convolutional layers. Residual neural networks utilize skip connections, or shortcuts to jump over some convolutional layers. Typical ResNet models are implemented with double- or triple-layer skips that contain nonlinearities (ReLU) and a batch normalization in-between.

In particular, an example of a text-dependent verification system based on a ResNet neural network is disclosed in the article “Zhong, Q., Dai, R., Zhang, H. et al. Text-independent speaker recognition based on adaptive course learning loss and deep residual network. EURASIP J. Adv. Signal Process. 2021, 45 (2021). https://doi.org/10.1186/s13634-021-00762-2”.

Despite of the fact that text-dependent verification systems based on a ResNet neural network are one of the most accurate verification systems on the market, there is still a problem with accuracy of speaker identification in a wide range of conditions. In particular, the accuracy of such text-dependent verification systems based on a ResNet neural network depends on a distance between a speaker and a microphone, an environment, a passphrase length, and some other specific parameters.

Therefore, developing an improved or optimized speaker identification system providing an improved accuracy of speaker identification is an important concern in the art.

### SUMMARY OF THE INVENTION

It is an object of the present invention to improve accuracy of speaker identification.

In a first aspect of the present invention, there is provided a method of identifying a speaker, the method being executed on a computing device, comprising: (i) extracting speech features from at least one keyword; (ii) producing a speaker vector by feeding the extracted speech features to a pre-trained neural network; wherein the pre-trained neural network is comprised of a convolutional neural network, the convolutional neural network serving as a backbone and providing a backbone embedding, and a neural subnetwork; wherein the convolutional neural network comprises an input stem using the fed speech features as an input and residual blocks grouped in a set of subsequent stages, wherein the input stem and the stages are stacked next to each other to define residual network levels, each level providing reduction of a feature matrix dimension and generating a level output; wherein the neural subnetwork comprises a stack of paired convolutional layers, each pair corresponding to one of the residual network levels and using a level output generated by the residual network level as an input feature matrix, and generating an output; wherein one convolutional layer in each pair provides reduction of a feature matrix depth, and the other convolutional layer in each pair provides reduction of a feature matrix dimension; wherein each subsequent pair of convolutional layers, the subsequent pair corresponding to a subsequent residual network level, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous residual network level; wherein the pre-trained neural network produces the speaker vector as a resulting embedding based on the backbone embedding and a resulting feature matrix provided by the last pair of convolutional layers, the last pair corresponding to the last residual network level; and (iii) comparing the produced speaker vector with at least one of registered speaker vectors corresponding to known speakers to identify the speaker.

In an embodiment of the present invention according to the first aspect, the neural subnetwork may further comprise a pooling layer and a dense layer, and the resulting embedding generated by the pre-trained neural network may be produced by concatenating the backbone embedding with a result of processing the resulting feature matrix with the pooling and dense layers.

In a second aspect of the present invention, there is provided a method of identifying a speaker, the method being executed on a computing device, comprising: (i) extracting speech features from at least one keyword; (ii) producing a speaker vector by feeding the extracted speech features to a pre-trained neural network; wherein the pre-trained neural network is comprised of a convolutional neural network, the convolutional neural network serving as a backbone and providing a backbone embedding, and a neural subnetwork; wherein the convolutional neural network comprises an input stem using the fed speech features as an input and residual blocks grouped in a set of subsequent stages, each stage generating a stage output, wherein the input stem and the stages are stacked next to each other and provide each reduction of a feature matrix dimension; wherein the neural subnetwork comprises a stack of paired convolutional layers, each pair corresponding to one of the convolutional neural network stages and using a stage output generated by the convolutional neural network stage as an input feature matrix, and generating an output; wherein one convolutional layer in each pair provides reduction of a feature matrix depth, and the other convolutional layer in each pair provides reduction of a feature matrix dimension; wherein each subsequent pair of convolutional layers, the subsequent pair corresponding to a subsequent stage of the convolutional neural network, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous stage of the convolutional neural network; wherein the pre-trained neural network produces the speaker vector as a resulting embedding based on the backbone embedding and a resulting feature matrix provided by the last pair of convolutional layers, the last pair corresponding to the last stage of the convolutional neural network; and (iii) comparing the produced speaker vector with at least one of registered speaker vectors corresponding to known speakers to identify the speaker.

In an embodiment of the present invention according to the second aspect, the neural subnetwork may further comprise a pooling layer and a dense layer, and the resulting embedding generated by the pre-trained neural network may be produced by concatenating the backbone embedding with a result of processing the resulting feature matrix with the pooling and dense layers.

In a third aspect of the present invention, there is provided a speech-processing device for identifying a speaker, the device comprising: (1) a communication module for receiving or capturing a speech signal corresponding to the speaker; (2) a speaker-identification module connected to the communication module to receive the speech signal therefrom and performing at least the following operations: (i) detecting at least one keyword in the speech signal; (ii) extracting speech features from at least one keyword; (iii) producing a speaker vector by feeding the extracted speech features to a pre-trained neural network; wherein the pre-trained neural network is comprised of a convolutional neural network, the convolutional neural network serving as a backbone and providing a backbone embedding, and a neural subnetwork; wherein the convolutional neural network comprises an input stem using the fed speech features as an input and residual blocks grouped in a set of subsequent stages, wherein the input stem and the stages are stacked next to each other to define residual network levels, each level providing reduction of a feature matrix dimension and generating a level output; wherein the neural subnetwork comprises a stack of paired convolutional layers, each pair corresponding to one of the residual network levels and using a level output generated by the residual network level as an input feature matrix, and generating an output; wherein one convolutional layer in each pair provides reduction of a feature matrix depth, and the other convolutional layer in each pair provides reduction of a feature matrix dimension; wherein each subsequent pair of convolutional layers, the subsequent pair corresponding to a subsequent residual network level, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous residual network level; wherein the pre-trained neural network produces the speaker vector as a resulting embedding based on the backbone embedding and a resulting feature matrix provided by the last pair of convolutional layers, the last pair corresponding to the last residual network level; and (iv) comparing the produced speaker vector with at least one of registered speaker vectors corresponding to known speakers to identify the speaker.

In a fourth aspect of the present invention, there is provided a speech-processing device for identifying a speaker, the device comprising: (1) a communication module for receiving or capturing a speech signal corresponding to the speaker; (2) a speaker-identification module connected to the communication module to receive the speech signal therefrom and performing at least the following operations: (i) detecting at least one keyword in the speech signal; (ii) extracting speech features from at least one keyword; (iii) producing a speaker vector by feeding the extracted speech features to a pre-trained neural network; wherein the pre-trained neural network is comprised of a convolutional neural network, the convolutional neural network serving as a backbone and providing a backbone embedding, and a neural subnetwork; wherein the convolutional neural network comprises an input stem using the fed speech features as an input and residual blocks grouped in a set of subsequent stages, each stage generating a stage output, wherein the input stem and the stages are stacked next to each other and provide each reduction of a feature matrix dimension; wherein the neural subnetwork comprises a stack of paired convolutional layers, each pair corresponding to one of the convolutional neural network stages and using a stage output generated by the convolutional neural network stage as an input feature matrix, and generating an output; wherein one convolutional layer in each pair provides reduction of a feature matrix depth, and the other convolutional layer in each pair provides reduction of a feature matrix dimension; wherein each subsequent pair of convolutional layers, the subsequent pair corresponding to a subsequent stage of the convolutional neural network, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous stage of the convolutional neural network; wherein the pre-trained neural network produces the speaker vector as a resulting embedding based on the backbone embedding and a resulting feature matrix provided by the last pair of convolutional layers, the last pair corresponding to the last stage of the convolutional neural network; and (iv) comparing the produced speaker vector with at least one of registered speaker vectors corresponding to known speakers to identify the speaker.

The present invention according to any of the above-disclosed aspects improves accuracy or quality of speaker identification due to a more detailed feature map produced by using the convolutional neural network (backbone) combined with the neural subnetwork. In other words, the improved accuracy or quality of speaker identification is conditioned by the improved accuracy of voice biometrics.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the drawings, wherein:

FIG. 1 shows a block diagram of a speech-processing device for identifying a speaker;

FIG. 2 shows a block diagram of a speaker-identification module;

FIG. 3 shows a generalized architecture of a pre-trained neural network;

FIG. 3a illustrates a two-layer ResNet block used in a ResNet neural network;

FIG. 3b illustrates a three-layer ResNet block used in a ResNet neural network;

FIG. 3c illustrates a ResNeXt block used in a ResNeXt neural network;

FIG. 3d illustrates three different variants of a SE-ResNet module used in a SE-ResNet neural network;

FIG. 3e illustrates a ResNeSt block used in a ResNeSt neural network;

FIG. 4 shows a flow diagram of a training methodology used for training the pre-trained neural network;

FIG. 5 illustrates a DenseNet block used in DenseNet neural network;

FIG. 6 shows a generalized architecture of a pre-trained neural network on the basis of the DenseNet-type neural network;

FIG. 7 shows a generalized architecture of a pre-trained neural network on the basis of the DenseNet-type neural network on the basis of the EfficientNet-type neural network;

FIG. 8 is a flow diagram of a method of identifying a speaker;

FIG. 9 is a flow diagram of another method of identifying a speaker.

### DETAILED DESCRIPTION OF THE PREFERRED EMBODIMENTS

The present invention will now be described more fully with reference to the accompanying drawings, in which example embodiments of the present invention are illustrated. The subject matter of this disclosure may, however, be embodied in many different forms and should not be construed as being limited to the embodiments set forth herein.

The following example embodiments of the present invention are provided for identifying a speaker when human speech signals are used. However, the present invention is not limited to processing human speech signals; in particular, the present invention is also applicable for identifying a speaker when other sound or voice signals are used.

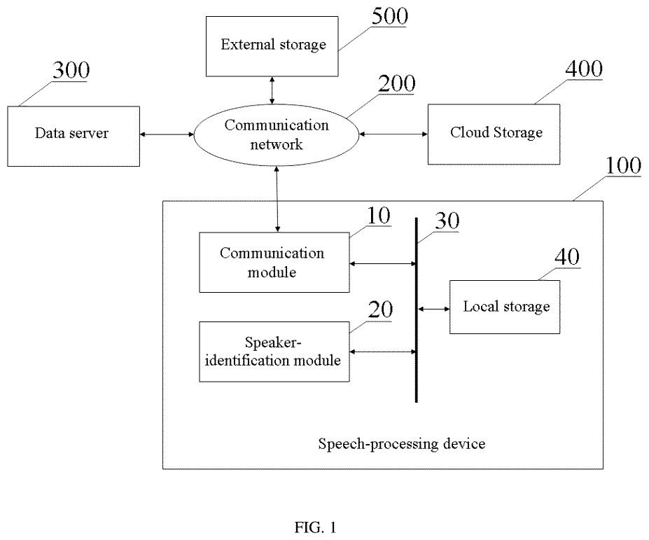

FIG. 1 is a block diagram illustrating a speech-processing device 100 according to a first aspect of the present invention. The speech-processing device 100 is configured to identify a speaker by processing a speaker speech signal, the speech signal corresponding to an unknown user or speaker. In other words, the speech-processing device 100 shown in FIG. 1 allows an unknown speaker's identity to be determined based on a speech signal corresponding to the unknown speaker, i.e. the speech-processing device 100 may be used to answer the question “Who is speaking?”. Furthermore, the speech-processing device 100 shown in FIG. 1 may be used to authenticate or verify the identity of a speaker based on a speech signal corresponding to the speaker, i.e. the speech-processing device 100 may be used to recognize when the same speaker is speaking, in particular in case when it is required to provide an access to the speaker to a secure system.

Therefore, there are two major applications of the speech-processing device 100 shown in FIG. 1. In particular, speaker identification is the process of determining from which of the registered speakers a given utterance comes. Speaker verification is the process of accepting or rejecting the identity claimed by a speaker. Most of the applications where a voice or speech signal is used to confirm the identity of a speaker are classified as speaker verification.

In the speaker identification task, a speech utterance from an unknown speaker is analyzed and compared with speech models or templates of known speakers. The unknown speaker is identified as the speaker whose speech model or template (also referred to in the present document as an enroll) best matches the input utterance. In speaker verification, an identity is claimed by an unknown speaker, and an utterance of this unknown speaker is compared with a speech model or template for the speaker whose identity is being claimed. If the match is good enough, i.e. above a pre-defined threshold, the identity claim is accepted. A high threshold makes it difficult for impostors to be accepted, but with the risk of falsely rejecting valid users. Conversely, a low threshold enables valid users to be accepted consistently, but with the risk of accepting impostors. To set the threshold at the desired level of customer rejection (false rejection) and impostor acceptance (false acceptance), data showing distributions of customer and impostor scores are used.

The fundamental difference between identification and verification is the number of decision alternatives. In identification, the number of decision alternatives is equal to the size of the population, whereas in verification there are only two choices, acceptance or rejection, regardless of the population size. Therefore, speaker identification performance decreases as the size of the population increases, whereas speaker verification performance approaches a constant independent of the size of the population, unless the distribution of physical characteristics of speakers is extremely biased.

As shown in FIG. 1, the speech-processing device 100 is comprised of two main functional modules: a communication module 10 and a speaker-identification module 20. The speech-processing device 100 also comprises a local storage 40 and a communication bus 30, wherein the speaker-identification module 20 is communicatively coupled to the communication module 10 via the communication bus 30, and the communication module 10 and the speaker-identification module 20 are each communicatively coupled to the local storage 40.

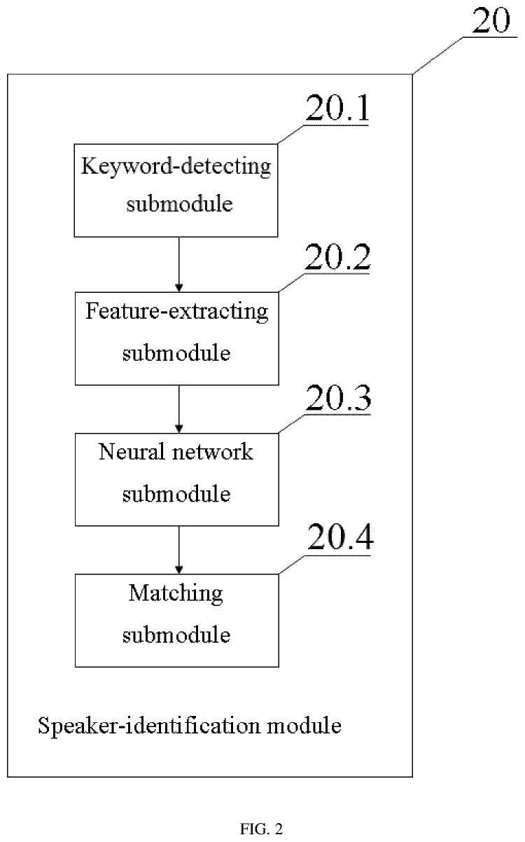

Functionalities of the communication module 10 and speaker-identification module 20 will be fully described below with reference to FIGS. 1-2.

The communication module 10 may be communicatively connected via a communication network 200 to a data server 300, a cloud storage 400, external storage 500 or other similar external devices used for storing speech signals so as to receive therefrom at least one speech signal to be processed by the speech-processing device 100 for speaker identification. In one embodiment of the present invention, the communication module 10 may be connected directly to the data server 300, a cloud storage 400, external storage 500 in a wire manner.

The communication network 200 shown in FIG. 1 may be in the form of Internet, 3G network, 4G network, 5G network, Wi-Fi network or any other wire or wireless network supporting appropriate data communication technologies.

The communication module 10 may be implemented as a network adapter provided with slots appropriate for connecting physical cables of desired types thereto if wired connections are provided between the speech-processing device 100 and any external devices mentioned in the present document. Alternatively, if wireless connections are provided between the speech-processing device 100 and any external devices mentioned in the present document, the communication module 10 may be implemented as a network adapter in form of WiFi-adaptor, 3G/4G/5G-adaptor, LTE-adaptor or any other appropriate adaptor supporting any known wireless communication technology. In an embodiment of the present invention, the communication module 10 may be implemented as a network adaptor supporting a combination of the above-mentioned wire or wireless communication technologies depending on types of connections provided between the speech-processing device 100 and any external devices mentioned in the present document.

Each speech signal received by the communication module 10 is transmitted via the communication bus 30 directly to the speaker-identification module 20 to allow the speech signal to be processed by the speaker-identification module 20 to identify the speaker based on the speech signal. In another embodiment of the present invention, the speech signal received by the communication module 10 may be transmitted via the communication bus 30 to the local storage 40 to be stored therein, and the speaker-identification module 20 may access the local storage 40 via the communication bus 30 to retrieve the previously stored speech signal to further process it for identifying the speaker.

The speaker-identification module 20 and any other data-processing modules mentioned in the present document may be each implemented as a single processor, such as a common processor or a special-purpose processor (e.g., a digital signal processor, an application-specific integrated circuit, or the like). For example, the speaker-identification module 20 may be in the form of a central processing unit of the below-mentioned general-purpose computer (common computer) which may be the implementation of the speech-processing device 100.

In some embodiments of the present invention, the communication module 10 in the speech-processing device 100 may further communicatively connected to a packet capture device (not shown) in wire or wireless manner, in particular via the communication network 200. The packet capture device may be connected to the communication network 200 to capture data packets transmitted via the communication network 200 (network traffic) and to transmit the captured data packets to the communication module 10; the speaker-identification module 20 may further comprises a filtering or analyzing module (not shown) communicatively connected to the communication module 10 and the speaker-identification module 20 via the communication bus 30 to process the data packets received by the communication module 10. The analyzing module may be further configured or programmed to extract all files comprised in the data packets received from the communication module 10 and to analyze each of the extracted files to identify its format, wherein the analyzing module is further configured or programmed to transmit each file having any audio format known in the art, i.e. each file corresponding to a voice or speech signal, to the speaker-identification module 20 via the communication bus 30 for speaker identification.

In other embodiments of the present invention, an external device communicatively connected to the communication module 10 may be any voice-recording or voice-capturing device known in the art, e.g. microphone, phone headset, sound recorder or any other electronic or audio device configured to record or capture voice or speech and configured to communicate it in a wireless or wired manner, so that the speech-processing device 100 may receive, via the communication module 10, the recorded or captured voice signal from the external device.

The speech-processing device 100 may be preferably implemented as a modern smartphone, smart speaker or any another smart device with a voice interface. The speech-processing device 100 may be also used, for example, in telephone channels, call centers, IVRs, or etc.

In various embodiments of the present invention, the speech-processing device 100 may be in the form of a computing device comprised of a combination of a hardware and software or a general-purpose computer having a structure known for those skilled in the art. In an embodiment of the present invention, the speech-processing device 100 may be implemented as a single computer server, such as «Dell™ PowerEdge™» server running the operating system «Ubuntu Server 18.04». In some embodiments of the present invention, the speech-processing device 100 may be in the form of a table computer, laptop, netbook, smartphone, tablet and any other electronical or computing device appropriate for solving the above-mentioned prior art problems. In other embodiments of the present invention, the speech-processing device 100 may be implemented in any other suitable hardware, software, and/or firmware, or a combination thereof. A particular implementation of the speech-processing device 100 is not limited by the above-mentioned examples.

The local storage 40 stores executable program instructions or commands allowing the operation of functional modules integrated to the speech-processing device 100 to be controlled, wherein said functional modules are the communication module 10, the speaker-identification module 20 and any other functional modules mentioned in the present document as a part of the speech-processing device 100. Meanwhile, such executable program instructions or commands as stored in the local storage 40 also allow the functional modules of the speech-processing device 100 to implement their functionalities. Furthermore, the local storage 40 stores different additional data used by the functional modules to provide their outputs.

The local storage 40 may be realized as a memory, a hard disk drive or any appropriate long-term storage. For example, the local storage 40 may be in the form of a data storage of the above-mentioned general-purpose computer which may be the implementation of the speech-processing device 100.

Each speech signal received by the speaker-identification module 20 from the communication module 10 or retrieved by the speaker-identification module 20 from the local storage 40 (depending on a particular embodiment of the present invention) is processed by the speaker-identification module 20 by preforming the below-mentioned operations, thereby allowing the speaker to be verified or identified by the speaker-identification module 20 on the basis of the processed speech signal.

As shown in FIG. 2, the speaker-identification module 20 comprises a keyword-detecting submodule 20.1, a feature-extracting submodule 20.2, a neural network submodule 20.3 and a matching submodule 20.4, wherein the keyword-detecting submodule 20.1 is communicatively coupled to the feature-extracting submodule 20.2, the feature-extracting submodule 20.2 is communicatively coupled to the neural network submodule 20.3, and the neural network submodule 20.3 is communicatively coupled to the matching submodule 20.4 It is to note that a result generated by the speaker-identification module 20 is substantially an output provided by the matching submodule 20.4.

The keyword-detecting submodule 20.1 is communicatively connected to the communication module 10 to receive the speech signal therefrom. In another embodiment of the present invention, the keyword-detecting submodule 20.1 may be communicatively coupled to the local storage 40 via the communication bus 30 to receive the speech signal stored therein.

In one embodiment of the present invention, the speech-processing device 100 may comprise a speech-capturing device (not shown) integrated to the speech-processing device 100, e.g. microphone having a sensitive transducer element for capturing a voice or speech signal. It is to note that the speech-capturing device in such embodiment of the present invention may be substantially used instead of the communication module 10, so that the speech-capturing device may be communicatively coupled to the speaker-identification module 20 and to the local storage 40 via the communication bus 30, thereby allowing the captured speech signal to be communicated to the speaker-identification module 20. In particular, the keyword-detecting submodule 20.1 may be communicatively coupled to the speech-capturing device to receive the captured speech signal therefrom.

The keyword-detecting submodule 20.1 is configured to detect at least one keyword in the speech signal.

It is to note that the speech signal may correspond to a predetermined or arbitrary utterance spoken by an unknown speaker, wherein the speaker utterance may contain at least one keyword or keywords (also referred to in the art as trigger words, wake up words, wake words, hot words). In other words, the utterance spoken by the speaker may contain a predefined password or passphrase consisting of one keyword or at least two keywords used for smart speakers, such as “Alexa”, “Ok Google”, “Hey Siri”, “Verify my voice”, “My voice is my password”, etc.

It is to further note that keywords may be recognized or detected, by means of the keyword-detecting submodule 20.1, in the speaker utterance by using at least one of the following keyword spotting methods or techniques known in the art (also referred to in the art as keyword detection techniques): sliding window and garbage model, k-best hypothesis, iterative Viterbi decoding, convolutional neural network on Mel-frequency cepstrum coefficients, transformer-based small-footprint keyword spotting, etc. Some modern and well-known keyword spotting techniques are described, for example, in the article “Berg, A., O'Connor, M., Cruz, M. T. (2021) Keyword Transformer: A Self-Attention Model for Keyword Spotting. Proc. Interspeech 2021, 4249-4253, doi: 10.21437/Interspeech.2021-1286” and the article “A. H. Michaely, X. Zhang, G. Simko, C. Parada and P. Aleksic. Keyword spotting for Google assistant using contextual speech recognition, 2017 IEEE Automatic Speech Recognition and Understanding Workshop (ASRU), 2017, pp. 272-278, doi:10.1109/ASRU.2017.8268946”.

The feature-extracting submodule 20.2 is communicatively connected to the keyword-detecting submodule 20.1 to receive the detected keyword therefrom. In another embodiment of the present invention, the feature-extracting submodule 20.2 may be communicatively coupled to the local storage 40 via the communication bus 30 to receive the keyword stored therein.

The feature-extracting submodule 20.2 is configured to perform the following two main actions or operations:
(i) extracting speech features from the keyword detected by the keyword-detecting submodule 20.1; and
(ii) feeding the extracted speech features to the neural network submodule 20.3.

Furthermore, it is to note that speech features to be extracted by the feature-extracting submodule 20.2 from the detected keyword are a set of low dimensional vectors that represent characteristics of speaker speech (speaker voice biometrics). In particular, the feature-extracting submodule 20.2 may use at least one of the following feature extraction methods or techniques known in the art: Short-time Fourier transform (STFT Spectrogram), Mel scale filter bank (Mel Banks), Mel Frequency Cepstral Coefficients (MFCC), Frequency spectrum of a sinc function (Sinc), GD-Gram, Linear Prediction Coefficients (LPC), Linear Prediction Cepstral Coefficients (LPCC), Line Spectral Frequencies (LSF), Discrete Wavelet Transform (DWT) and Perceptual Linear Prediction (PLP), Raw signal. Some modern and well-known feature extraction techniques are described, for example, in the article “S. A. Alim, and N. K A. Rashid, “Some Commonly Used Speech Feature Extraction Algorithms”, in From Natural to Artificial Intelligence—Algorithms and Applications. London, United Kingdom: IntechOpen, 2018 [Online]. Available: https://www.intechopen.com/chapters/63970 doi: 10.5772/intechopen.80419”.

In one embodiment of the present invention, the keyword-detecting submodule 20.1 may be a separate keyword detector configured to perform the above-mentioned functionality assigned to the keyword-detecting submodule 20.1, i.e. detection of at least one keyword in the speech signal; the feature-extracting submodule 20.2 may be a separate speech feature extractor connected to the keyword detector and configured to perform the above-mentioned main functionality assigned to the feature-extracting submodule 20.2, i.e. extraction of speech features from the detected keyword.

In another embodiment of the present invention, the speech signal received or captured by the speech-processing device 100 in the above-described manner may be substantially at least one keyword or keywords to be used by the above-described feature-extracting submodule 20.2 for extracting speech features therefrom, so that the keyword-detecting submodule 20.1 and the above operation of the keyword-detecting submodule 20.1 may be omitted, and the feature-extracting submodule 20.2 may be configured to perform its operations (i) and (ii). In one alternative of such embodiment of the present invention, keywords used by the feature-extracting submodule 20.2 for extracting speech features therefrom may be originally received by the communication module 10 from one of the above-mentioned external devices, such as data server 300, cloud server 400, external storage 50 or a similar external device used for storing keywords and then communicated to the feature-extracting submodule 20.2 via the communication bus 30. In another alternative of such embodiment of the present invention, keywords used by the feature-extracting submodule 20.2 for extracting speech features therefrom may be originally received by the communication module 10 from an external voice-recording or voice-capturing device configured to record or capture keywords spoken by the speaker and configured to communicate it in a wireless or wired manner In still another alternative of such embodiment of the present invention, keywords used by the feature-extracting submodule 20.2 for extracting speech features therefrom may be originally recorded or captured by a keyword-capturing device integrated to the speech-processing device 100 for recording or capturing keywords spoken by the speaker. In each of the above alternatives of such embodiment of the present invention, the keywords to be used by the feature-extracting submodule 20.2 may be communicated by the communication module 10 directly to the feature-extracting submodule 20.2 by using the communication bus 30 or extracted by the feature-extracting submodule 20.2 from the local storage 40 by using the communication bus 30.

The neural network submodule 20.3 communicatively connected to the feature-extracting submodule 20.2 receives the extracted speech features and feed them as an initial input feature matrix to a pre-trained neural network having an improved or optimized architecture developed by the authors of the present invention, so that a speaker vector is finally generated or produced by the neural network submodule 20.3. In other words, the neural network submodule 20.3 processes the speech features (initial input feature matrix) fed by the feature-extracting submodule 20.2 in order to produce the speaker vector.

The pre-trained neural network used by the neural network submodule 20.3 is comprised of a convolutional neural network, the convolutional neural network serving as a backbone (main neural network) and providing a backbone embedding, and a neural subnetwork. The pre-trained neural network process the speech features (initial input feature matrix) in the below-described manner, in particular passes the speech features through a set of different functional layers (e.g. convolutional layers, pooling layers and dense layers) grouped in a particular structured manner, and outputs or returns the speaker vector corresponding to the speaker, wherein the returned speaker vector is substantially a low-dimensional feature vector (a resulting embedding of the pre-trained neural network) representing individual characteristics of the speaker's voice.

The convolutional neural network forming a structural part of the pre-trained neural network may be (i) a residual neural network or ResNet neural network having a standard architecture selected from a group consisting of ResNet18, ResNet34, ResNet50, ResNet101 and ResNet152 (five types); (ii) a densely connected convolutional network or DenseNet neural network having a standard architecture selected from a group consisting of DenseNet-121, DenseNet-169, DenseNet-201 and DenseNet-264 (four types); (iii) ResNeXt neural network; (iv) SE-ResNet neural network; (v) SE-ResNeXt neural network; (vi) EfficientNet neural network; (vii) ResNeSt neural network or (viii) any similar convolutional neural network (CNN). It is to note that referred to in the present document as a ResNet-type neural network are neural networks having the followings examples of standard architectures: ResNet18, ResNet34, ResNet50, ResNet101, ResNet152, ResNeXt, SE-ResNet, SE-ResNeXt, ResNeSt and similar architectures.

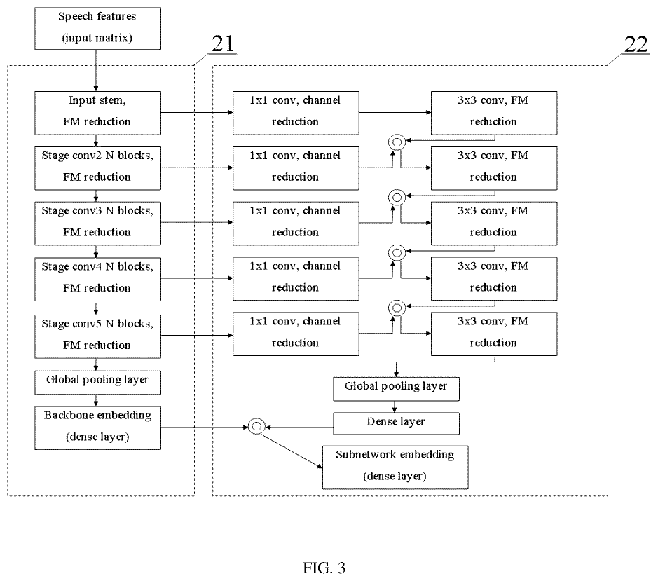

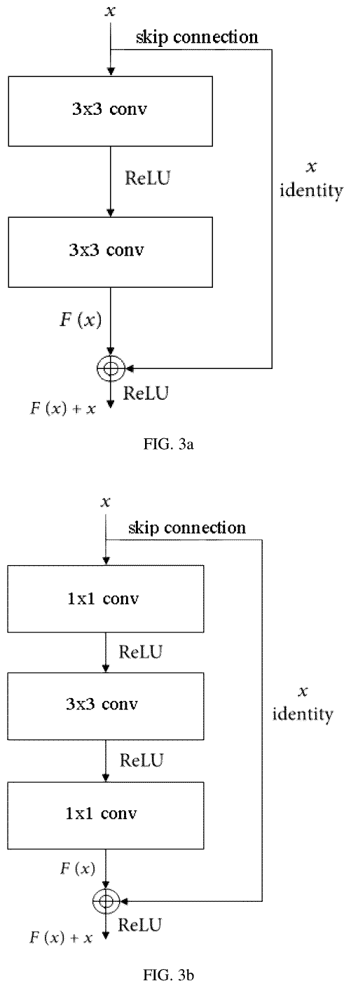

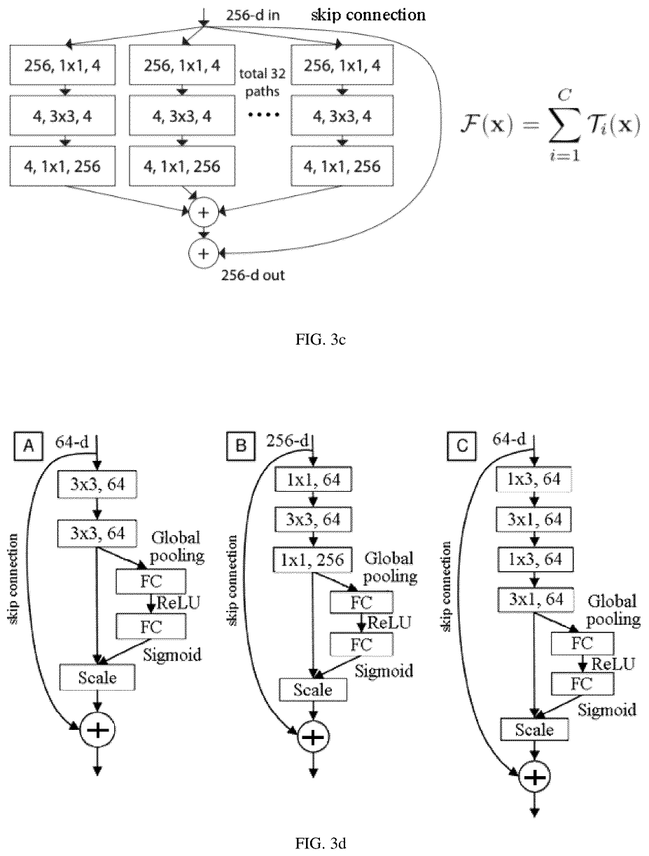

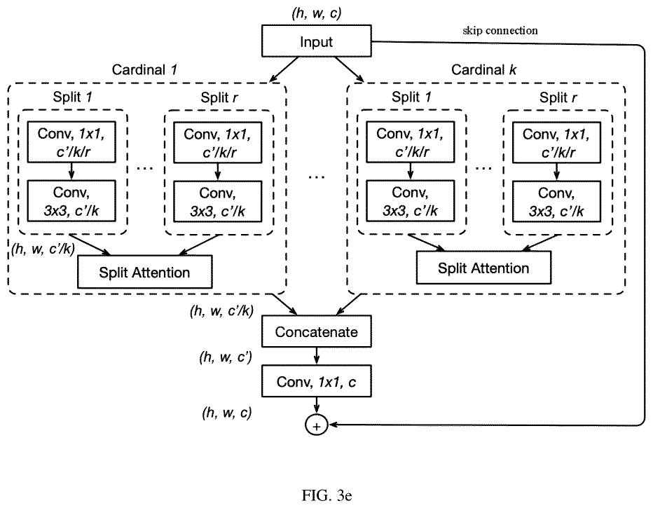

FIG. 3 illustrates a variant of a consolidated or generalized architecture of the pre-trained neural network used by the neural network submodule 20.3 in a case when the ResNet-type neural network (i.e. the residual neural network having any one of the following known architectures: ResNet18, ResNet34, ResNet50, ResNet101, ResNet152, ResNeXt, SE-ResNet, SE-ResNeXt, ResNeSt and similar architectures) is used as the backbone in the pre-trained neural network.

As shown in FIG. 3, the ResNet-type neural network used as the backbone in the pre-trained neural network comprises an input stem using the speech features fed by the feature-extracting submodule 20.2 as an input (i.e. the input stem receives the input feature matrix communicated by the feature-extracting submodule 20.2 to the neural network submodule 20.3) and stacked residual blocks (also referred to in the art as building residual blocks or ResBlocks) grouped in a set of subsequent stages, wherein the input stem and the stages are stacked next to each other to form or define residual network levels, each level providing reduction of a feature matrix dimension and generating a level output.

In particular, the ResNet-type neural network shown in FIG. 3 comprises four subsequent stages; all the stages and the input stem substantially form five residual network levels, wherein the input stem corresponds to the first residual network level, and each of the stages correspond to a particular one of the remaining residual network levels (i.e. the first stage corresponds to the second residual network level; the second stage corresponds to the third residual network level; the third stage corresponds to the fourth residual network level; the fourth stage corresponds to the fifth residual network level).

It is to note that the input stem in the ResNet-type neural network shown in FIG. 3 corresponds to an initial convolution operation with a filter size of 3×3 and a stride of 2. It is to further note that the input stem corresponding to the first residual network level substantially provides reduction of the feature matrix dimension (FM reduction).

As also shown in FIG. 3, each stage in the ResNet-type neural network comprises a particular number (N) of stacked residual blocks, wherein each residual block is comprised of a set of convolutional layers with different numbers of channels. It is to note that the ResNet-type neural network of FIG. 3 utilizes skip connections (also referred to in the art as shortcut connections, shortcuts, residual connections or identity connections) to jump over some convolutional layers.

Each residual block used in the stages forming the ResNet-type neural network shown in FIG. 3 has the same design illustratively shown in FIG. 3a or FIG. 3b. It is to note that only the first residual block in each stage of the ResNet-type neural network provides the reduction of the feature matrix dimension (FM reduction), i.e. the first convolution operation has a stride of 2.

FIG. 3a illustrates a residual block having a depth of two layers (used, for example, in smaller ResNet-type neural networks like ResNet 18, 34), wherein the residual block of FIG. 3a has a double-layer skip having a nonlinearity (ReLU) and a batch normalization in between. In particular, the residual block of FIG. 3a has two stacked 3×3 convolutional layers with the same number of output channels (each convolutional layer substantially corresponds to a convolution operation with a filter size of 3×3), wherein each convolutional layer is followed by a batch normalization layer and a ReLU activation function. It is to note that the two convolutional layers in the residual block of FIG. 3a have the identical structure, and the skip connection used in the residual block of FIG. 3a is the identity mapping of an input (x). The skip connection in the residual block of FIG. 3a allows two convolution operations to be skipped and the input (x) to be added directly before the final ReLU function. The residual block design shown in FIG. 3a requires that an output of the two convolutional layers has to be of the same dimension as an input, so that they can be added or combined together in the summator (i.e. the addiction layer).

The output generated by each residual block shown in FIG. 3a may be written as follows:

y=F(x)+x, (1)

where F(x) presents the residual function, and x and y stand for the input and output, respectively.

Therefore, in view of the above, the residual block of FIG. 3a provides two paths: the sequential connection between two convolutional layers and the skip connection, wherein the sequential connection conducts two consecutive convolutions on the input (x) to get the residual function F(x), the residual function F(x) being used as a one of two inputs for a summator (a unit corresponding to the addiction layer), and the skip connection allows the input (x) to be obtained as the other input for the summator.

FIG. 3b illustrates a residual block having a depth of three layers (used, for example, in larger ResNet-type neural networks like ResNet 50, 101, 152), wherein the residual block of FIG. 3b has a triple-layer skip having nonlinearities (ReLU) and a batch normalization in between. In particular, the residual block of FIG. 3b has three stacked convolutional layers: a first 3×3 convolutional layer, a second 1×1 convolutional layer and a third 3×3 convolutional layer, wherein each of the first and third convolutional layers substantially corresponds to a convolution operation with a filter size of 3×3, and the second convolutional layer substantially corresponds to a convolution operation with a filter size of 1×1. It is to note that each convolutional layer in the residual block of FIG. 3b is also followed by a batch normalization layer and a ReLU activation function. The skip connection used in the residual block of FIG. 3b is the identity mapping of an input (x), so that the skip connection allows three convolution operations to be skipped and allows the input (x) to be added directly before the final ReLU function. The residual block design shown in FIG. 3b also requires that an output of the three convolutional layers has to be of the same dimension as an input, so that they can be added or combined together in the summator (i.e. the addiction layer).

The output generated by each residual block shown in FIG. 3b may be written as follows:

H(x)=F(x)+x, (2)

where F(x) presents the residual function, and x and H(x) stand for the input and output, respectively.

Therefore, in view of the above, the residual block of FIG. 3b provides two paths: the sequential connection between two convolutional layers and the skip connection, wherein the sequential connection conducts three consecutive convolutions on the input (x) to get the residual function F(x), the residual function F(x) being used as a one of two inputs for a summator (a unit corresponding to the addiction layer), and the skip connection allows the input (x) to be obtained as the other input for the summator. It is to note that the residual block of FIG. 3b is sometimes referred to in the art as a bottleneck building block.

Also, as shown in FIG. 3, the ResNet-type neural network used as the backbone in the pre-trained neural network further comprises a global pooling layer and a dense layer to sequentially process the last level output generated by the last residual network level corresponding to the last stage of the ResNet-type neural network, thereby providing the backbone embedding. It is to note that the global pooling layer in the ResNet-type neural network substantially process the last level output used an input in the form of [batch, time, frequency, channels] and proves an output in the form of [batch, frequency*channels*2]. It is to further note that the dense layer in the ResNet-type neural network is not followed by a batch normalization layer and a ReLU activation function and substantially reduce the dimension of the output provided by the global pooling layer. It is to note that a statistical pooling layer may be used instead of the above-mentioned global pooling layer in a preferred embodiment of the present invention.

The below Table 1 shows features of illustrative variants for the following standard architectures of the ResNet neural network that can be used as the convolutional neural network in the neural network submodule 20.3: ResNet18, ResNet34, ResNet50, ResNet101 and ResNet152.

TABLE 1
Illustrative architectures of the ResNet neural network

| layer name | output size | 18-layer | 34-layer | 50-layer | 101-layer | 152-layer |
|---|---|---|---|---|---|---|
| conv1 | 112 × 112 | 7 × 7, 64, stride 2 | | | | |
| conv2.x | 56 × 56 | 3 × 3 max pool, stride 2 | | | | |
| | | $[ \begin{matrix}3 \times 3 , 64 \\ 3 \times 3 , 64\end{matrix} ] \times 2$ | $[ \begin{matrix}3 \times 3 , 64 \\ 3 \times 3 , 64\end{matrix} ] \times 3$ | $[ \begin{matrix}1 \times 1 , 64 \\ 3 \times 3 , 64 \\ 1 \times 1 , 256\end{matrix} ] \times 3$ | $[ \begin{matrix}1 \times 1 , 64 \\ 3 \times 3 , 64 \\ 1 \times 1 , 256\end{matrix} ] \times 3$ | $[ \begin{matrix}1 \times 1 , 64 \\ 3 \times 3 , 64 \\ 1 \times 1 , 256\end{matrix} ] \times 3$ |
| conv3.x | 28 × 28 | $[ \begin{matrix}3 \times 3 , 128 \\ 3 \times 3 , 128\end{matrix} ] \times 2$ | $[ \begin{matrix}3 \times 3 , 128 \\ 3 \times 3 , 128\end{matrix} ] \times 4$ | $[ \begin{matrix}1 \times 1 , 128 \\ 3 \times 3 , 128 \\ 1 \times 1 , 512\end{matrix} ] \times 4$ | $[ \begin{matrix}1 \times 1 , 128 \\ 3 \times 3 , 128 \\ 1 \times 1 , 512\end{matrix} ] \times 4$ | $[ \begin{matrix}1 \times 1 , 128 \\ 3 \times 3 , 128 \\ 1 \times 1 , 512\end{matrix} ] \times 8$ |
| conv4.x | 14 × 14 | $[ \begin{matrix}3 \times 3 , 256 \\ 3 \times 3 , 256\end{matrix} ] \times 2$ | $[ \begin{matrix}3 \times 3 , 256 \\ 3 \times 3 , 256\end{matrix} ] \times 6$ | $[ \begin{matrix}1 \times 1 , 256 \\ 3 \times 3 , 256 \\ 1 \times 1 , 1024\end{matrix} ] \times 6$ | $[ \begin{matrix}1 \times 1 , 256 \\ 3 \times 3 , 256 \\ 1 \times 1 , 1024\end{matrix} ] \times 23$ | $[ \begin{matrix}1 \times 1 , 256 \\ 3 \times 3 , 256 \\ 1 \times 1 , 1024\end{matrix} ] \times 36$ |
| conv5.x | 7 × 7 | $[ \begin{matrix}3 \times 3 , 512 \\ 3 \times 3 , 512\end{matrix} ] \times 2$ | $[ \begin{matrix}3 \times 3 , 512 \\ 3 \times 3 , 512\end{matrix} ] \times 3$ | $[ \begin{matrix}1 \times 1 , 512 \\ 3 \times 3 , 512 \\ 1 \times 1 , 2048\end{matrix} ] \times 3$ | $[ \begin{matrix}1 \times 1 , 512 \\ 3 \times 3 , 512 \\ 1 \times 1 , 2048\end{matrix} ] \times 3$ | $[ \begin{matrix}1 \times 1 , 512 \\ 3 \times 3 , 512 \\ 1 \times 1 , 2048\end{matrix} ] \times 3$ |

| | |
|---|---|
| 1 × 1 | average pool, 1000-d fc, softmax |

| | | | | | |
|---|---|---|---|---|---|
| FLOPs | 1.8 × 10⁹ | 3.6 × 10⁹ | 3.8 × 10⁹ | 7.6 × 10⁹ | 11.3 × 10⁹ |

As shown in the above Table 1, inside the brackets are a shape of a residual block, and outside the brackets is the number of stacked residual blocks in a particular stage of the residual neural network (in particular, the layer Conv_2 corresponds to the first stage, and the layer Conv_3 corresponds to the second stage, and the layer Conv_4 corresponds to the third stage, and the layer Conv_5 corresponds to the fourth stage).

Thus, the bottleneck building block shown in FIG. 3b allows each of the ResNet-50, ResNet-101 and ResNet-152 to add further convolutional layers. In particular, as shown in Table 1, the difference between ResNet-50, ResNet-101 and ResNet-152 is in that the ResNet-50 adds another six layers, the ResNet-101 adds another 23 layers, and the ResNet-152 used to add another 36 layers.

Further, as mentioned above, the ResNeXt neural network may be also provided as the convolutional neural network (i.e. the backbone) used in the pre-trained neural network of the neural network submodule 20.3. The ResNeXt neural network has an architecture generally corresponding to that of the above-described ResNet neural network.

Table 2 shows the architecture of the ResNeXt neural network versus the architecture of the ResNet neural network, wherein the ResNeXt-50 and the ResNet-50 are used as representative examples. As shown in Table 2, inside the brackets are a shape of a residual block, and outside the brackets is the number of stacked residual blocks in a particular stage of the residual neural network (in particular, the layer Conv_2 corresponds to the first stage, and the layer Conv_3 corresponds to the second stage, and the layer Conv_4 corresponds to the third stage, and the layer Conv_5 corresponds to the fourth stage), and C=32 suggests grouped convolutions [24] with 32 groups. As follows from Table 2, a number of parameters and FLOPs are similar between the ResNeXt neural network and the ResNet neural network.

The ResNeXt neural network is a homogeneous neural network reducing the number of hyperparameters required by a conventional ResNet neural network. In particular, the ResNeXt neural network repeats a special residual block (ResNeXt block) that aggregates a set of transformations with the same topology. Compared to the ResNet neural network, the ResNeXt neural network uses a new or further dimension called “cardinality” (C) as an essential factor in addition to the dimensions of width and depth that are typical for the ResNet neural network, wherein the cardinality defines a size of the set of transformations.

FIG. 3c illustrates a conventional ResNeXt block having a cardinality of 32, so that the same transformations are applied 32 times, and the result is aggregated at the end. Each convolutional layer shown in the ResNeXt block of FIG. 3c has the following parameters: (# in channels, filter size, # out channels). Formally, a set of aggregated transformations can be represented as follows:

Σᵢ₌₁^{C}Ti(x) (3)

where Ti(x) can be an arbitrary function. Similarly to a simple neuron, Ti should project x into an (optionally low-dimensional) embedding and then transform it.

TABLE 2
Illustrative architecture of the ResNeXt neural network

| stage | output | ResNet-50 | ResNeXt-50 (32 × 4d) |
|---|---|---|---|
| conv1 | 112 × 112 | 7 × 7, 64, stride 2 | 7 × 7, 64, stride 2 |
| conv2 | 56 × 56 | 3 × 3 max pool, stride 2 | 3 × 3 max pool, stride 2 |
| | | $[ \begin{matrix}1 \times 1 , 64 \\ 3 \times 3 , 64 \\ 1 \times 1 , 256\end{matrix} ] \times 3$ | $[ \begin{matrix}1 \times 1 , 128 \\ 3 \times 3 , 128 \\ 1 \times 1 , 256\end{matrix} , C = 32 ] \times 3$ |
| conv3 | 28 × 28 | $[ \begin{matrix}1 \times 1 , 128 \\ 3 \times 3 , 128 \\ 1 \times 1 , 512\end{matrix} ] \times 4$ | $[ \begin{matrix}1 \times 1 , 256 \\ 3 \times 3 , 256 \\ 1 \times 1 , 512\end{matrix} , C = 32 ] \times 4$ |
| conv4 | 14 × 14 | $[ \begin{matrix}1 \times 1 , 256 \\ 3 \times 3 , 256 \\ 1 \times 1 , 1024\end{matrix} ] \times 6$ | $[ \begin{matrix}1 \times 1 , 512 \\ 3 \times 3 , 512 \\ 1 \times 1 , 1024\end{matrix} , C = 32 ] \times 6$ |
| conv5 | 7 × 7 | $[ \begin{matrix}1 \times 1 , 512 \\ 3 \times 3 , 512 \\ 1 \times 1 , 2048\end{matrix} ] \times 3$ | $[ \begin{matrix}1 \times 1 , 1024 \\ 3 \times 3 , 1024 \\ 1 \times 1 , 2048\end{matrix} , C = 32 ] \times 3$ |
| | 1 × 1 | global average pool | global average pool |
| | | 1000-d fc, softmax | 1000-d fc, softmax |

| | | |
|---|---|---|
| # params. | 25.5 × 10⁶ | 25.0 × 10⁶ |
| FLOPs | 4.1 × 10⁹ | 4.2 × 10⁹ |

The ResNeXt block shown in FIG. 3c is comprised of a pre-determined number of convolution paths, in particular 32 convolution paths (the cardinality (C) is equal to 32), wherein each convolution paths substantially corresponds to the ResNet block shown in FIG. 3b (i.e. the bottleneck design of the ResNet block). As shown in FIG. 3c, for each convolution path corresponding to the ResNet block of FIG. 3b, a first convolution operation with a filter size of 1×1, a second convolution operation with a filter size of 3×3 and a third convolution operation with a filter size of 1×1 are sequentially performed to provide a path output, i.e. three convolution operations are performed at each convolution path. As also shown in FIG. 3c, an internal dimension for each convolution path is denoted as d (d=4), wherein the dimension is increased from 4 to 256. Furthermore, as also shown in FIG. 3c, all the path outputs are added together in a first summator (i.e. a first addiction layer), and then added with a skip connection path in a second summator (i.e. a second addiction layer). Therefore, the ResNet neural network may be generally considered as a special variant of the ResNeXt neural network with C=1, and d=64.

The ResNeXt neural network is described in more details, for example, in the article “Saining Xie, Ross B. Girshick, Piotr Dollár, Z. Tu, Kaiming He. Aggregated Residual Transformations for Deep Neural Networks, 2017 IEEE Conference on Computer Vision and Pattern Recognition (CVPR), 2017, https://doi.org/10.48550/arXiv.1611.05431”.

Further, the SE-ResNet neural network is a variant of the ResNet neural network that employs squeeze-and-excitation blocks (SE blocks) to enable the network to perform dynamic channel-wise feature recalibration. The SE-ResNet neural network is built upon the convolution operation, which extracts informative features by fusing spatial and channel-wise information within local receptive fields. The core module of the SE-ResNet neural network is a combination of Squeeze-and-Excitation block (SE block) and the residual block of the ResNet (i.e. SE-ResNet module).

It is to note that the SE block in the SE-ResNet module adaptively recalibrates channel-wise feature responses by explicitly modelling interdependencies between channels. Recalibrating a filter response involves two steps: a squeeze phase and an excitation phase. The first step (i.e. the squeeze phase) uses the global average pooling to squeeze a global spatial information into a channel descriptor. To make use of the information aggregated in the squeeze operation, it is followed with a second step (the excitation phase) which aims to capture channel-wise dependencies fully. A skip connection used in the SE-ResNet module ensures that a gradient is always greater than or equal to 1 in the back-propagation, thereby avoiding the gradient disappearance problem of CNN. The most significant difference between with the ResNet block and the SE-ResNet module is in that the SE-ResNet module makes use of a global average pooling operation in the squeeze phase and two small fully connected layers in the excitation phase, followed by a channel-wise scaling operation.

FIG. 3d(A) illustrates a conventional or basic SE-ResNet module having two consecutive 3×3 convolutional layers (i.e. two consecutive convolution operations each having a filter size of 3×3) with a batch normalization and a ReLU preceding convolution, and then it is combined with an SE block having the following structure: conv3×3-conv3×3 (i.e. two consecutive convolutional layers: a first convolutional layer with a filter size of 3×3, and a second convolutional layer with a filter size of 3×3). Thus, the SE block used in the basic SE-ResNet module of FIG. 3d(A) substantially corresponds to the ResNet block of FIG. 3a.

FIG. 3d(B) illustrates a bottleneck SE-ResNet module having one 3×3 convolutional layer (i.e. one convolution operation with a filter size of 3×3) surrounded by dimensionality reducing and expanding 1×1 convolutional layers (i.e. two convolution operations with a filter size of 1×1), and then it is combined with an SE block having the following structure: conv1×1-conv3×3-conv1×1 (i.e. three consecutive convolutional layers: a first convolutional layer with a filter size of 1×1, a second convolutional layer with a filter size of 3×3, and a third convolutional layer with a filter size of 1×1). Thus, the SE block used in the bottleneck SE-ResNet module of FIG. 3d(B) substantially corresponds to the ResNet block of FIG. 3b.

FIG. 3d(C) illustrates a small SE-ResNet module having two consecutive 1×3 and 3×1 convolutional layers (i.e. two convolution operations, one having a filter size of 1×3, and the other having a filter size of 3×1) with a batch normalization and a ReLU preceding convolution, then it is combined with an SE block having the following structure: conv1×3-conv3×1-conv1×3-conv3×1 (i.e. four consecutive convolutional layers: a first convolutional layer with a filter size of 1×3, a second convolutional layer with a filter size of 3×1, a third convolutional layer with a filter size of 1×3, and a fourth convolutional layer with a filter size of 3×1).

Compared with the bottleneck SE-ResNet module of FIG. 3d(B) and the basic SE-ResNet module of FIG. 3d(A), the small SE-ResNet module of FIG. 3d(C) is designed to reduce parameters of the residual neural network.

The SE-ResNet neural network is described in more details, for example, in the article “Jiang Y, Chen L, Zhang H, Xiao X (2019). Breast cancer histopathological image classification using convolutional neural networks with small SE-ResNet module. PLoS ONE 14(3): e0214587. https://journals.plos.org/plosone/article?id=10.1371/journal.pone.0214587” or in the article “J. Hu, L. Shen and G. Sun, “Squeeze-and-Excitation Networks,” 2018 IEEE/CVF Conference on Computer Vision and Pattern Recognition, 2018, pp. 7132-7141, doi: 10.1109/CVPR.2018.00745”.

Further, the SE-ResNeXt neural network is a variant of the ResNext neural network shown in the above Table 2 that employs squeeze-and-excitation blocks to enable the residual neural network to perform dynamic channel-wise feature recalibration.

The below Table 3 shows features of an illustrative variant for a standard architecture of the SE-ResNet neural network and an illustrative variant of a standard architecture of the SE-ResNeXt neural network (with a 32×4d template) that can be used as the convolutional neural network in the neural network submodule 20.3, wherein the architectures of the SE-ResNet neural network and the SE-ResNeXt neural network are presented in comparison to a standard architecture of the ResNet neural network.

TABLE 3
Illustrative architectures of the SE-ResNet neural network and the SE-ResNeXt neural network

| Output size | ResNet-50 | SE-ResNet-50 | SB-ResNeXt-50 (32 × 4d) |
|---|---|---|---|
| 112 × 112 | conv, 7 × 7, 64, stride 2 | | |
| 56 × 56 | max pool, 3 × 3, stride 2 | | |
| | $[ \begin{matrix}conv , 1 \times 1 , 64 \\ conv , 3 \times 3 , 64 \\ conv , 1 \times 1 , 256\end{matrix} ] \times 3$ | $[ \begin{matrix}conv , 1 \times 1 , 64 \\ conv , 3 \times 3 , 64 \\ conv , 1 \times 1 , 256 \\ fc , [ 16 , 256 ]\end{matrix} ] \times 3$ | $[ \begin{matrix}conv , 1 \times 1 , 128 \\ conv , 3 \times 3 , 128 \\ conv , 1 \times 1 , 256 \\ fc , [ 16 , 256 ]\end{matrix} C = 32 ] \times 3$ |
| 28 × 28 | $[ \begin{matrix}conv , 1 \times 1 , 128 \\ conv , 3 \times 3 , 128 \\ conv , 1 \times 1 , 512\end{matrix} ] \times 4$ | $[ \begin{matrix}conv , 1 \times 1 , 128 \\ conv , 3 \times 3 , 128 \\ conv , 1 \times 1 , 512 \\ fc , [ 32 , 512 ]\end{matrix} ] \times 4$ | $[ \begin{matrix}conv , 1 \times 1 , 256 \\ conv , 3 \times 3 , 256 \\ conv , 1 \times 1 , 512 \\ fc , [ 32 , 512 ]\end{matrix} C = 32 ] \times 4$ |
| 14 × 14 | $[ \begin{matrix}conv , 1 \times 1 , 256 \\ conv , 3 \times 3 , 256 \\ conv , 1 \times 1 , 1024\end{matrix} ] \times 6$ | $[ \begin{matrix}conv , 1 \times 1 , 256 \\ conv , 3 \times 3 , 256 \\ conv , 1 \times 1 , 1024 \\ fc , [ 64 , 1024 ]\end{matrix} ] \times 6$ | $[ \begin{matrix}conv , 1 \times 1 , 512 \\ conv , 3 \times 3 , 512 \\ conv , 1 \times 1 , 1024 \\ fc , [ 64 , 1024 ]\end{matrix} C = 32 ] \times 6$ |
| 7 × 7 | $[ \begin{matrix}conv , 1 \times 1 , 512 \\ conv , 3 \times 3 , 512 \\ conv , 1 \times 1 , 2048\end{matrix} ] \times 3$ | $[ \begin{matrix}conv , 1 \times 1 , 512 \\ conv , 3 \times 3 , 512 \\ conv , 1 \times 1 , 2048 \\ fc , [ 128 , 2048 ]\end{matrix} ] \times 3$ | $[ \begin{matrix}conv , 1 \times 1 , 1024 \\ conv , 3 \times 3 , 1024 \\ conv , 1 \times 1 , 2048 \\ fc , [ 128 , 2048 ]\end{matrix} C = 32 ] \times 3$ |

| | |
|---|---|
| 1 × 1 | global average pool, 1000-d fc, softmax |

As shown in the above Table 3, inside the brackets are shapes and operations with specific parameter settings of a residual block, and outside the brackets is the number of stacked residual blocks in a particular stage of the residual neural network (in particular, the layer with an output size 56×56 corresponds to the first stage, and the layer with an output size 28×28 corresponds to the second stage, and the layer with an output size 14×14 corresponds to the third stage, and the layer with an output size 7×7 corresponds to the fourth stage). Thus, the above Table 3 illustratively shows that the SE-ResNet neural network, the SE-ResNeXt neural network and the ResNet neural network have similar architectures, so that each of these convolutional neural networks has the consolidated or generalized architecture of the pre-trained neural network as shown in FIG. 3.

Further, the ResNeSt neural network is a variant of the ResNet neural network that stacks Split-Attention blocks or ResNeSt blocks shown in FIG. 3e, wherein each ResNeSt block enables feature-map attention across different feature-map groups. As shown in FIG. 3e, the ResNeSt block consists of a feature-map group and split attention operations. Like the ResNeXt block shown in FIG. 3c, the feature is divided into several groups, and the number of feature-map groups controlled by a cardinality hyperparameter K. In other words, the ResNeXt block shown in FIG. 3c performs as ResNeXt to apply multi-path of the input, then in each cardinal (path) the split attention is used. The ResNeSt block adds a new radix hyperparameter R that indicates the number of splits within a cardinal group, so the total number of feature groups is G=KR. In the ResNeSt block, cardinal group representations are concatenated along a channel dimension: V=Concat{V1,V2, . . . VX}. As in standard residual blocks, a final output Y of another ResNeSt block is produced using a skip connection: Y=V+X, if an input feature-map and an output feature-map share the same shape. For blocks with a stride, an appropriate transformation T is applied to the skip connection to align the output shapes: Y=V+T(X). For example, T can be a strided convolution or combined convolution-with-pooling.

Therefore, the above-described architecture of the ResNeSt neural network is similar to that of the ResNet neural network, so that the ResNeSt neural network has the consolidated or generalized architecture of the pre-trained neural network as shown in FIG. 3.

The SE-ResNet neural network is described in more details, for example, in the article “Zhang, Hang and Wu, Chongruo and Zhang, Zhongyue and Zhu, Yi and Zhang, Zhi and Lin, Haibin and Sun, Yue and He, Tong and Mueller, Jonas and Manmatha, R and others. ResNeSt: Split-Attention Networks. https://doi.org/10.48550/arXiv.2004.08955”.

As shown in FIG. 3, the neural subnetwork in the pre-trained neural network used by the neural network submodule 20.3 comprises a stack of paired convolutional layers, each pair corresponding to one of the residual network levels and using a level output generated by the residual network level as an input feature matrix, and generating an output corresponding to a particular residual network level. In particular, as shown in FIG. 3, the first pair (initial pair) of convolutional layers in the neural subnetwork corresponds to the first residual network level or the input stem of the convolutional neural network; the second pair of convolutional layers in the neural subnetwork corresponds to the second residual network level or the first stage of the convolutional neural network; the third pair of convolutional layers in the neural subnetwork corresponds to the third residual network level or the second stage of the convolutional neural network; the fourth pair of convolutional layers in the neural subnetwork corresponds to the fourth residual network level or the third stage of the convolutional neural network; the fifth pair of convolutional layers in the neural subnetwork corresponds to the fifth residual network level or the fourth stage of the convolutional neural network. In other words, a number of pairs of convolutional layers substantially corresponds to a number of residual network levels provided in the convolutional neural network, so that there are five (5) pairs of convolutional layers in the neural subnetwork, each pair corresponding to a particular one of five residual network levels.

Meanwhile, as also shown in FIG. 3, one convolutional layer in each pair of provides reduction of a feature matrix depth (channel reduction), and the other convolutional layer in each pair provides reduction of a feature matrix dimension (FM reduction). In particular, in each pair of convolutional layers shown in FIG. 3, the convolutional layer providing reduction of a feature matrix depth is 1×1 convolutional layer (i.e. it provides a convolution operation with a filter size of 1×1) and uses a particular one of the generated level outputs as an input, wherein the used level output and the pair of convolutional layers substantially correspond to the same residual network level. Also, in each pair of convolutional layers shown in FIG. 3, the convolutional layer providing reduction of a feature matrix dimension is 3×3 convolutional layer (i.e. it provides a convolution operation with a filter size of 3×3) and is connected to its convolutional layer providing reduction of a feature matrix depth.

In the initial (first) pair of convolutional layers that corresponds to the first residual network level or the input stem of the convolutional neural network, as compared to the remaining pair of convolutional layers, the output provided by the convolutional layer providing reduction of a feature matrix depth is used as an input by the convolutional layer providing reduction of a feature matrix dimension to provide an output corresponding to the initial (first) pair of convolutional layers. In other words, in the initial (first) pair of convolutional layers, the input for the convolutional layer providing reduction of a feature matrix dimension is an output of the convolutional layer providing reduction of a feature matrix depth, the output being a compressed feature matrix and being produced by performing the convolution operation with the filter size of 1×1 and reducing a feature matrix depth for the level output generated by the initial (first) residual network level, an output of the convolutional layer providing reduction of a feature matrix dimension is a further compressed feature matrix produced by performing the convolution operation with the filter size of 3×3 and reducing the feature matrix dimension for the above-mentioned input for the convolutional layer providing reduction of a feature matrix dimension. It is to note that the feature matrix dimension may be reduced in one of the standard ways known for a skilled person: (1) adding a stride=2 for reducing a height and a weight of a feature matrix (also referred to in the art as a feature map) in two times; and (2) using a MaxPooling/AveragePooling layer having a stride of 2 after performing a convolution.

Further, as shown in FIG. 1, each subsequent pair of convolutional layers (i.e. each of the second, third, fourth and fifth pairs of convolutional layers in the neural subnetwork), the subsequent pair corresponding to a subsequent residual network level, also generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous residual network level.

In other words, in each of the second, third, fourth and fifth pairs of convolutional layers in the neural subnetwork (correspond to the second third, fourth and fifth residual network level, respectively), the generated compressed feature matrix is an output provided by corresponding convolutional layer providing reduction of a feature matrix dimension, wherein the input for the convolutional layer providing reduction of a feature matrix dimension is a result of concatenating an output of the convolutional layer providing reduction of a feature matrix depth with an output provided by a previous pair of convolutional layers (i.e. the pair of convolutional layers that corresponds to a previous residual network level). For example, a feature matrix generated by the second pair of convolutional layers is an output provided by its convolutional layer providing reduction of the feature matrix dimension, wherein the input for the convolutional layer providing reduction of a feature matrix dimension is a result of concatenating an output provided by the convolutional layer providing reduction of the feature matrix depth with an output provided by the initial (first) pair of convolutional layers (in particular, the first pair of convolutional layers is previous with regard to the second pair of convolutional layers). The above description provided for the second pair of convolutional layers is also applicable to each of the third, fourth and fifth pairs of convolutional layers.

As also shown in FIG. 3, the pre-trained neural network of the neural network submodule 20.3 produces the speaker vector as a resulting embedding based on the backbone embedding and a resulting feature matrix provided by the last pair of convolutional layers (in particular, the fifth pair of convolutional layers), the last pair corresponding to the last residual network level (in particular, the fifth residual network level). Furthermore, as shown in FIG. 3, the pre-trained neural network further comprises a pooling layer and a dense layer that both are designed to process the resulting feature matrix so as to produce the speaker vector, wherein the pooling layer and the dense layer are connected with each other such that an output provided by the pooling layer is fed to the dense layer or used by the dense layer as an input. In particular, the resulting embedding provided by the pre-trained neural network of the neural network submodule 20.3 is a result of concatenating the backbone embedding provided by the convolutional neural network with a result of processing the output provided by the last residual network level of the neural subnetwork with the combination of the pooling layer and the dense layer.

The convolutional neural network and the neural subnetwork combined with each other in above-described manner to form the pre-trained neural network of the neural network submodule 20.3 are trained in a specific manner on different datasets. In particular, the convolutional neural network is trained on a wide text-independent (free-text) datasets, while the neural subnetwork is trained on a text-dependent datasets only, so that this combination boosts the accuracy of the pre-trained neural network of the neural network submodule 20.3.

In other words, the training of the convolutional neural network is to be implemented by using free-text datasets. It means that the convolutional neural network is trained to recognize a speaker identity regardless of the phrase/text pronounced by the speaker. The training of the neural subnetwork is to be implemented by using text-dependent datasets only. It means that the neural subnetwork is trained to recognize a speaker identity when the speaker pronounces a predefined phrase/text only.

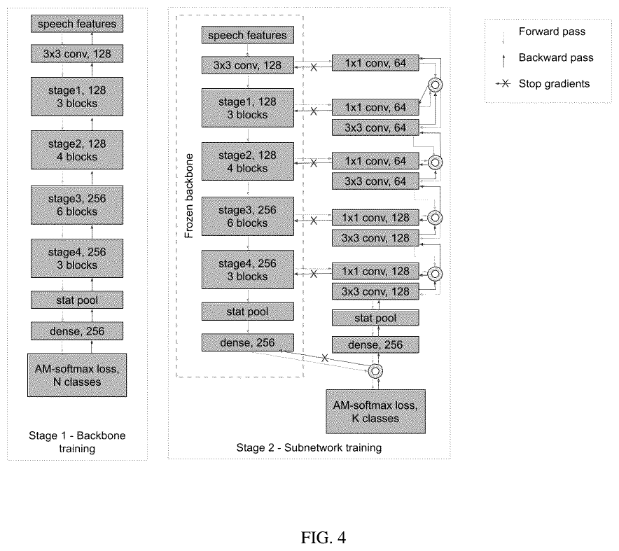

FIG. 4 illustrates a training methodology or procedure to be used for the combination of the convolutional neural network and the neural subnetwork to have the pre-trained neural network of the neural network submodule 20.3. It is to note that green arrows illustrated in FIG. 4 indicate the forward pass of the neural network training; red arrows illustrated in FIG. 4 indicate a backward pass when gradients are transferred back to the previous residual block to be used for updating corresponding block weights.

As shown in FIG. 4, the training procedure includes two main stages:
(1) the backbone (i.e. the convolutional neural network) is trained in a manner being appropriate for the type of the used convolutional neural network. However, the only requirement is in that free-text datasets are to be used for training the backbone;
(2) the weights of the backbone are fixed. The subnetwork weights are trained by using text-dependent datasets only. The weights of the backbone are used for the forward pass, but the backward pass is utilized for subnetwork only.

Further, the DenseNet neural network is also designed to be used as the convolutional neural network in the pre-trained neural network of the neural network submodule 20.3.

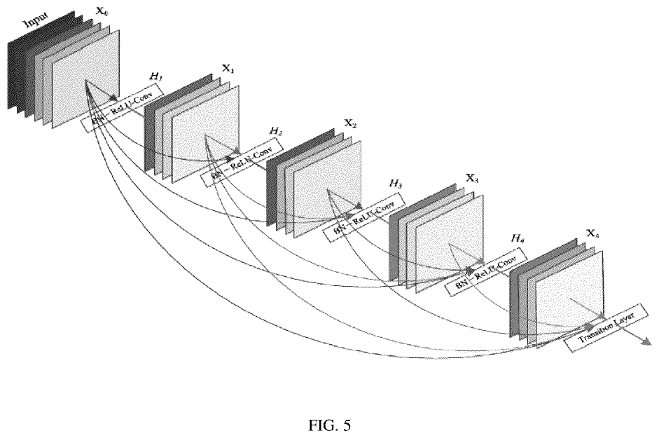

The DenseNet neural network is a convolutional neural network which utilizes dense connections between convolutional layers, wherein the DenseNet neural network offers several advantages such as mitigating the vanishing-gradient problem, encourage the propagation and reuse of feature maps which causes the reduction of parameters exploited. It is to note that the main idea of the DenseNet neural network is to ensure the maximum information transfer between the middle and layers of the DenseNet neural network, thus it can directly connect all layers. A DenseNet block shown in FIG. 5 is a core part of the DenseNet neural network, wherein the main feature of the DenseNet block is in that each convolutional layer is not only connected to the next convolutional layer, but also directly connected to each layer after this layer. In other words, in the DenseNet block shown in FIG. 5, each convolutional layer is connected to every other convolutional layer in a feed-forward manner, wherein the DenseNet block has L(L+1)/2 direct connections for L convolutional layers. An input of each convolutional layer comes from the output of all previous convolutional layers, so that the input of the convolutional layer is a concatenation of feature maps from previous convolutional layers.

Therefore, for each convolutional layer in the DenseNet block shown in FIG. 5, the feature-maps of all preceding convolutional layers are used as inputs, and its own feature-maps are used as inputs into all subsequent convolutional layers. In other words, to preserve the feed-forward nature, each convolutional layer obtains additional inputs from all preceding convolutional layers and passes on its own feature-maps to all subsequent convolutional layers.

The below Table 4 shows features of illustrative variants for the following standard architectures of the DenseNet neural network that can be used as the convolutional neural network in the neural network submodule 20.3: DenseNet-121, DenseNet-169, DenseNet-201 and DenseNet-264.

TABLE 4
Illustrative architectures of the DenseNet neural network

| Layers | Output Size | DenseNet-121 | DenseNet-169 | DenseNet-201 | DenseNet-264 |
|---|---|---|---|---|---|
| Convolution | 112 × 112 | 7 × 7 conv, stride 2 | | | |
| Pooling | 56 × 56 | 3 × 3 max pool, stride 2 | | | |
| Dense Block (1) | 56 × 56 | $[ \begin{matrix}1 \times 1 conv \\ 3 \times 3 conv\end{matrix} ] \times 6$ | $[ \begin{matrix}1 \times 1 conv \\ 3 \times 3 conv\end{matrix} ] \times 6$ | $[ \begin{matrix}1 \times 1 conv \\ 3 \times 3 conv\end{matrix} ] \times 6$ | $[ \begin{matrix}1 \times 1 conv \\ 3 \times 3 conv\end{matrix} ] \times 6$ |
| Transition Layer | 56 × 56 | 1 × 1 conv | | | |
| (1) | 28 × 28 | 2 × 2 average pool, stride 2 | | | |
| Dense Block (2) | 28 × 28 | $[ \begin{matrix}1 \times 1 conv \\ 3 \times 3 conv\end{matrix} ] \times 12$ | $[ \begin{matrix}1 \times 1 conv \\ 3 \times 3 conv\end{matrix} ] \times 12$ | $[ \begin{matrix}1 \times 1 conv \\ 3 \times 3 conv\end{matrix} ] \times 12$ | $[ \begin{matrix}1 \times 1 conv \\ 3 \times 3 conv\end{matrix} ] \times 12$ |
| Transition Layer | 28 × 28 | 1 × 1 conv | | | |
| (2) | 14 × 14 | 2 × 2 average pool, stride 2 | | | |
| Dense Block (3) | | $[ \begin{matrix}1 \times 1 conv \\ 3 \times 3 conv\end{matrix} ] \times 24$ | $[ \begin{matrix}1 \times 1 conv \\ 3 \times 3 conv\end{matrix} ] \times 32$ | $[ \begin{matrix}1 \times 1 conv \\ 3 \times 3 conv\end{matrix} ] \times 48$ | $[ \begin{matrix}1 \times 1 conv \\ 3 \times 3 conv\end{matrix} ] \times 64$ |
| Transition Layer | 14 × 14 | 1 × 1 conv | | | |
| (3) | 7 × 7 | 2 × 2 average pool, stride 2 | | | |
| Dense Block (4) | 7 × 7 | $[ \begin{matrix}1 \times 1 conv \\ 3 \times 3 conv\end{matrix} ] \times 16$ | $[ \begin{matrix}1 \times 1 conv \\ 3 \times 3 conv\end{matrix} ] \times 32$ | $[ \begin{matrix}1 \times 1 conv \\ 3 \times 3 conv\end{matrix} ] \times 32$ | $[ \begin{matrix}1 \times 1 conv \\ 3 \times 3 conv\end{matrix} ] \times 48$ |

| | | |
|---|---|---|
| Classification | 1 × 1 | 7 × 7 global average pool |
| Layer | | 1000D fully-connected, softmax |

As shown in the above Table 4, each architecture of the DenseNet neural network consists of four (4) DenseNet blocks of FIG. 5 with varying number of convolutional layers. For example, the DenseNet-121 has [6, 12, 24, 16] convolutional layers in the four DenseNet blocks, whereas DenseNet-169 has [6, 12, 32, 32] convolutional layers. As shown in the above Table 3, an initial part of any DenseNet architecture consists of a convolutional layer having a filter size of 7×7 and a stride of 2 (i.e. 7×7 cony, stride 2) followed by a MaxPooling layer having a filter size of 3×3 and a stride of 2 (i.e. 3×3 max pool, stride 2). Also, the fourth DenseNet block is followed by a Classification Layer that accepts the feature maps of all layers of the network to perform the classification. It is to note that convolution operations inside each of the architectures are the Bottle Neck layers, so that it means that the convolutional layer with a filter size of 1×1 (1×1 cony) reduces a number of channels in an input, and the convolutional layer with a filter size of 3×3 (3×3 cony) performs a convolution operation on the transformed version of the input with reduced number of channels rather than the input.

It is to further note that a combination of the neural subnetwork with each of the above-mentioned architectures of the DenseNet neural network (i.e. DenseNet-121, DenseNet-169, DenseNet-201 and DenseNet-264 as shown in FIG. 5) or with each of other architectures related to similar DenseNet-type neural networks may be described by using a consolidated or generalized architecture of the pre-trained neural network used by the neural network submodule 20.3.

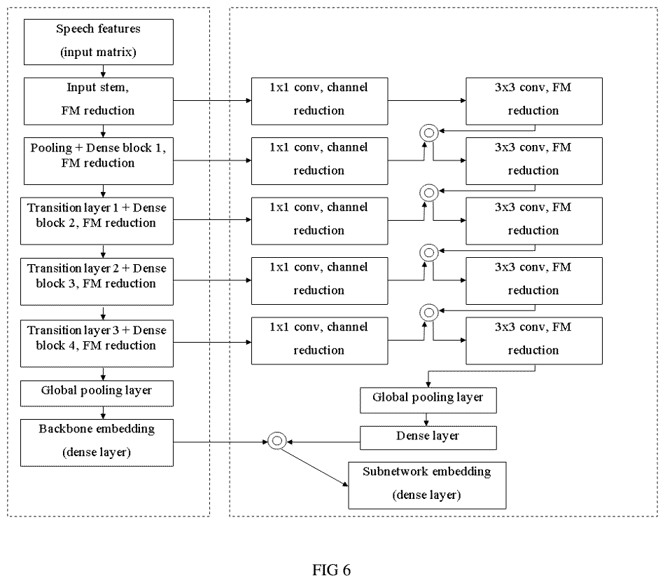

FIG. 6 illustrates the generalized architecture of the pre-trained neural network used by the neural network submodule 20.3 in a case when the DenseNet-type neural network (i.e. the residual neural network having any one of the following known architectures: DenseNet-121, DenseNet-169, DenseNet-201, DenseNet-232, DenseNet-264, DenseNet-BC, Wide-DenseNet-BC, DenseNet-cosine and similar architectures) is used as the backbone in the pre-trained neural network.

The generalized architecture of the pre-trained neural network as shown in FIG. 6 substantially corresponds to that shown in FIG. 3, so that the above description related to the pre-trained neural network of FIG. 3 is substantially applicable to the pre-trained neural network shown in FIG. 6. In other words, as clearly follows from the above description of the present document, the generalized architecture of the pre-trained neural network as shown in FIG. 3 covers the generalized architecture of the pre-trained neural network as shown in FIG. 6.

Further, the EfficientNet neural network is a convolutional neural network architecture and scaling method that uniformly scales all dimensions of depth/width/resolution using a compound coefficient. Unlike conventional practice that arbitrary scales these factors, the EfficientNet scaling method uniformly scales network width, depth, and resolution with a set of fixed scaling coefficients. For example, if we want to use 2^{N} times more computational resources, then we can simply increase the network depth by α^{N}, width by β^{N}, and image size by γ^{N}, where α, β, γ are constant coefficients determined by a small grid search on the original small model. The EfficientNet neural network uses a compound coefficient ϕ to uniformly scales network width, depth, and resolution in a principled way. The compound scaling method is justified by the intuition that if an input is bigger, then the EfficientNet neural network needs more convolutional layers to increase a receptive field and more channels to capture more fine-grained patterns on the bigger input.

A base EfficientNet-B0 neural network is based on inverted bottleneck residual blocks (also referred to in the art as a MobileNet block or MBConv) of a MobileNetV2 neural network, in addition to squeeze-and-excitation blocks.

It is to note that the above-mentioned MobileNetV2 neural network is a convolutional neural network architecture based on an inverted residual structure where residual connections are between bottleneck convolutional layers. An intermediate expansion layer in the MobileNetV2 neural network uses lightweight depthwise convolutions to filter features as a source of non-linearity. As a whole, the architecture of the MobileNetV2 neural network contains an initial fully convolution layer with 32 filters, followed by 19 residual bottleneck convolutional layers.

The below Table 5 illustrates a structure of the above-mentioned bottleneck residual block used in the EfficientNet neural network.

TABLE 5
Bottleneck residual block for the EfficientNet neural network

| Input | Operator | Output |
|---|---|---|
| h × ω × k | 1 × 1 conv2d, ReLU6 | h × ω × (tk) |
| h × ω × tk | 3 × 3 dwise s = s, ReLU6 | $\frac{h}{s} \times \frac{ω}{s} \times ( tk )$ |
| $\frac{h}{s} \times \frac{ω}{s} \times tk$ | linear 1 × 1 conv2d | $\frac{h}{s} \times \frac{ω}{s} \times {k}^{′}$ |

Therefore, a main building block in the EfficientNet neural network consists of the bottleneck residual block shown in Table 5 to which squeeze-and-excitation optimization is added, wherein the bottleneck residual block used in the EfficientNet neural network is similar to that used in the MobileNetV2 neural network. These form a skip connection between the beginning of a convolutional block and the end of the convolutional block. Input activation maps are first expanded using 1×1 convolutions to increase the depth of the feature maps. This is followed by 3×3 depth-wise convolutions and point-wise convolutions that reduce the number of channels in the output feature map. The skip connections connect the narrow layers, whilst the wider layers are present between the skip connections. This structure helps in decreasing the overall number of operations required as well as the model size.

The below Table 6 shows features of an illustrative variant of a standard architecture of the EfficientNet neural network that can be used as the convolutional neural network in the neural network submodule 20.3.

TABLE 6
Illustrative architecture of the EfficientNet neural network

| Stage | Operator | Resolution | #Channels | #Layers |
|---|---|---|---|---|
| i | [symbol] | Ĥᵢ × Ŵᵢ | Ĉᵢ | \hat{L}ᵢ |
| 1 | Conv3x3 | 224 × 224 | 32 | 1 |
| 2 | MBConv1, k3x3 | 112 × 112 | 16 | 1 |
| 3 | MBConv6, k3x3 | 112 × 112 | 24 | 2 |
| 4 | MBConv6, k5x5 | 56 × 56 | 40 | 2 |
| 5 | MBConv6, k3x3 | 28 × 28 | 80 | 3 |
| 6 | MBConv6, k5x5 | 14 × 14 | 112 | 3 |
| 7 | MBConv6, k5x5 | 14 × 14 | 192 | 4 |
| 8 | MBConv6, k3x3 | 7 × 7 | 320 | 1 |
| 9 | Conv1x1 & Pooling & FC | 7 × 7 | 1280 | 1 |

It is to further note that a combination of the neural subnetwork with the above-described architecture of the EfficientNet neural network (in particular, any of the known architectures of the EfficientNet neural network: from EfficientNet-B0 to EfficientNet-B7) or any similar architecture related to the EfficientNet-type neural networks may be described by using a consolidated or generalized architecture of the pre-trained neural network used by the neural network submodule 20.3.

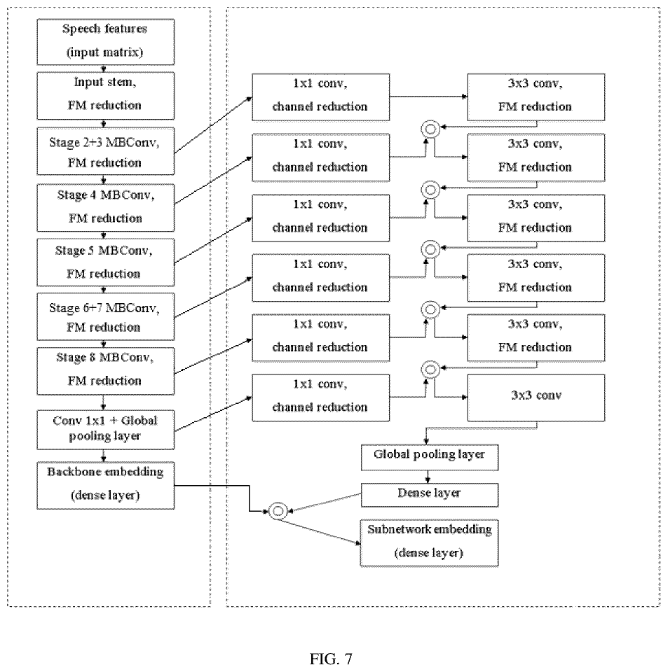

FIG. 7 illustrates the generalized architecture of the pre-trained neural network used by the neural network submodule 20.3 in a case when the EfficientNet -type neural network (i.e. the residual neural network having any one of the following known architectures: EfficientNet-B0, EfficientNet-B1, EfficientNet-B2, EfficientNet-B3, EfficientNet-B4, EfficientNet-B5, EfficientNet-B6, EfficientNet-B7 and similar architectures) is used as the backbone in the pre-trained neural network.

The generalized architecture of the pre-trained neural network as shown in FIG. 7 generally corresponds to that shown in FIG. 3, so that the above description related to the pre-trained neural network of FIG. 3 is generally applicable to the pre-trained neural network shown in FIG. 7. However, as shown in FIG. 7, the generalized architecture of the pre-trained neural network as shown in FIG. 7 differs from that shown in FIG. 3 in the following:
(1) the EfficientNet neural network further comprises one more stage and, therefore, contains one more residual network level corresponding to the further stage;
(2) The global pooling layer in the EfficientNet neural network is further accompanied with a convolution operation having a filter size of 1×1 (cony 1×1);
(3) The initial (first) residual network level corresponding to the input stem in the EfficientNet neural network does not provide its level output to the initial (first pair) of convolutional layers, while the initial (first pair) of convolutional layers is connected to the second residual network level corresponding to the first stage of the EfficientNet neural network such that a level output provided by the second residual network level is used by the first pair of convolutional layers as an input. In other words, each of the five (5) stages of the EfficientNet neural network is connected to corresponding one of the five (5) pairs of convolutional layers in the neural subnetwork.

The above-described alternative architecture of the pre-trained neural network as based on the EfficientNet neural network may be implemented in the speech-processing device 100 according to a second aspect of the present invention.

Generally speaking, the speech-processing device 1000 according to the second aspect of the present invention will be similar to the above-described speech-processing device 100 according to the first aspect of the present invention, i.e. the speech-processing device 100 according to the second aspect of the present invention has a structure and interconnections similar to that of the speech-processing device 100 according to the first aspect of the present invention (see FIGS. 1-3). In view of the above-mentioned similarity between the speech-processing devices 100, most of details related to the speech-processing device 1000 according to the second aspect of the present invention are omitted in the present document and provided therein as a reference to corresponding description of the speech-processing device 100 according to the first aspect of the present invention.

Further, the speaker vector produced by the neural network submodule 20.3 is communicated to the matching submodule 20.4. The matching submodule 20.4 is configured to compare the produced speaker vector with at least one of registered speaker vectors (also referred to in the art as enrolls) corresponding to known speakers, thereby allowing the speaker to be identified, wherein the registered speaker vectors (enrolls) may be preliminary stored in the local storage 40 and then extracted therefrom when performing the comparison operation. In an embodiment of the present invention, the registered speaker vectors (enrolls) may be preliminary stored in any suitable external data storage, in particular in the external storage 500, the cloud storage 400, data server 300 or any other similar external device used for storing enrolls, and then the stored enrolls may be requested by the matching submodule 20.4 from the external data storage by using the communication module 10. In other words, the result of the comparison operation allows the matching submodule 20.4 to make an identification decision (identification of an unknown speaker) or verification decision (recognition when the same speaker is speaking, resulting, for example, in rejection or acceptance of the identity claimed by the speaker).

In case when a defined task is verification of an unknown speaker, the matching submodule 20.4 compared the speaker vector received from the neural network submodule 20.3 with only one enroll available to the matching submodule 20.4 so as to reject or accept the identity claimed by the unknown speaker, thereby allowing, for example, an access to the speaker to a secure system.

In case when a defined task is identification of an unknown speaker, the matching submodule 20.4 compared the speaker vector received from the neural network submodule 20.3 with all the enrolls available for the matching submodule 20.4 so as to identify who of the registered speakers corresponds to the speech signal received by the speaker-identification module 20. In particular, the unknown speaker is identified by the matching submodule 20.4 as the speaker whose enroll best matches the speaker vector received from the neural network submodule 20.3.

In particular, to compare the received speaker vector with at least one enroll, the matching submodule 20.4 may be configured to use at least one of the following known matching methods: cosine metrics between two vectors, PLDA scoring, SVM and a combination of the above methods.

For example, a matching score may be used as a metric or measurement to quantify the similarity between the speaker vector received by the matching submodule 20.4 and at least one enroll being available to the matching submodule 20.4. In the verification process, if a matching score between the received speaker vector and corresponding enroll being available to the matching submodule 20.4 is computed by the matching submodule 20.4, the computed matching score then needs to be compared by the matching submodule 20.4 with only one predefined threshold. If the matching score is higher than the predefined threshold, the overall verification decision made by the matching submodule 20.4 will be “Accept”, wherein otherwise the matching submodule 20.4 will make the “Reject” decision. It is to note that the predefined threshold may be preliminary computed for a particular enroll when training the pre-trained convolutional neural network used by the neural network submodule 20.3, wherein the computed threshold may be stored in any data storage device being available to the matching submodule 20.4. If the identification process is required to be performed by the matching submodule 20.4, the matching submodule 20.4 will reveal the best match between the predefined threshold being available to the matching submodule 20.4 and the matching score computed by the matching submodule 20.4 for the received speaker vector and a corresponding one of the available enrolls.

As another example, a cosine similarity may be used as a metric or measurement to quantify the similarity between the speaker vector received by the matching submodule 20.4 and at least one enroll being available to the matching submodule 20.4. In the verification process, if a cosine similarity (it will a number in the range from −1 to +1) between the received speaker vector and a corresponding enroll being available to the matching submodule 20.4 is computed by the matching submodule 20.4, the computed cosine similarity then needs to be compared by the matching submodule 20.4 with only one predefined threshold. If the cosine similarity is higher than the predefined threshold, the overall verification decision made by the matching submodule 20.4 will be “Accept”, wherein otherwise the matching submodule 20.4 will make the “Reject” decision. It is to note that the predefined threshold may be preliminary computed for a particular enroll when training the pre-trained convolutional neural network used by the neural network submodule 20.3, wherein the computed threshold may be stored in any data storage device being available to the matching submodule 20.4. If the identification process is required to be performed by the matching submodule 20.4, the matching submodule 20.4 will reveal the best match between the predefined threshold being available to the matching submodule 20.4 and the cosine similarity computed by the matching submodule 20.4 for the received speaker vector and a corresponding one of the available enrolls.

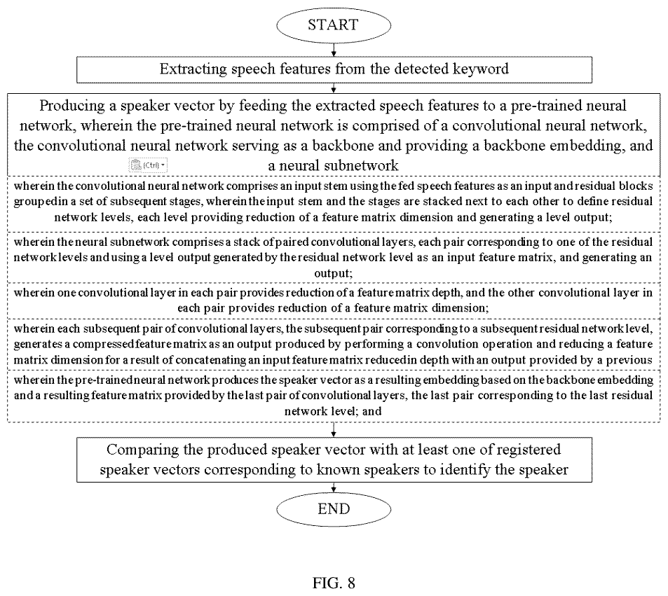

FIG. 8 illustrates a flow diagram of a method of identifying a speaker according to a third aspect of the present invention.

The method of FIG. 8 is implemented by the above the speech-processing device 100 according to the first aspect of the present invention. Anyway, the method of FIG. 8 may be implemented by any computing or electronic device known in the art, in particular by a processing unit of the above-mentioned general-purpose computer.

The method of FIG. 8 comprises the following stages or steps:
(1) extracting speech features from at least one keyword;
(2) producing a speaker vector by feeding the extracted speech features to a pre-trained neural network;
   wherein the pre-trained neural network is comprised of a convolutional neural network, the convolutional neural network serving as a backbone and providing a backbone embedding, and a neural subnetwork;
   wherein the convolutional neural network comprises an input stem using the fed speech features as an input and residual blocks grouped in a set of subsequent stages, wherein the input stem and the stages are stacked next to each other to define residual network levels, each level providing reduction of a feature matrix dimension and generating a level output;
   wherein the neural subnetwork comprises a stack of paired convolutional layers, each pair corresponding to one of the residual network levels and using a level output generated by the residual network level as an input feature matrix, and generating an output;
   wherein one convolutional layer in each pair provides reduction of a feature matrix depth, and the other convolutional layer in each pair provides reduction of a feature matrix dimension;
   wherein each subsequent pair of convolutional layers, the subsequent pair corresponding to a subsequent residual network level, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous residual network level;
   wherein the pre-trained neural network produces the speaker vector as a resulting embedding based on the backbone embedding and a resulting feature matrix provided by the last pair of convolutional layers, the last pair corresponding to the last residual network level; and
(3) comparing the produced speaker vector with at least one of registered speaker vectors corresponding to known speakers to identify the speaker.

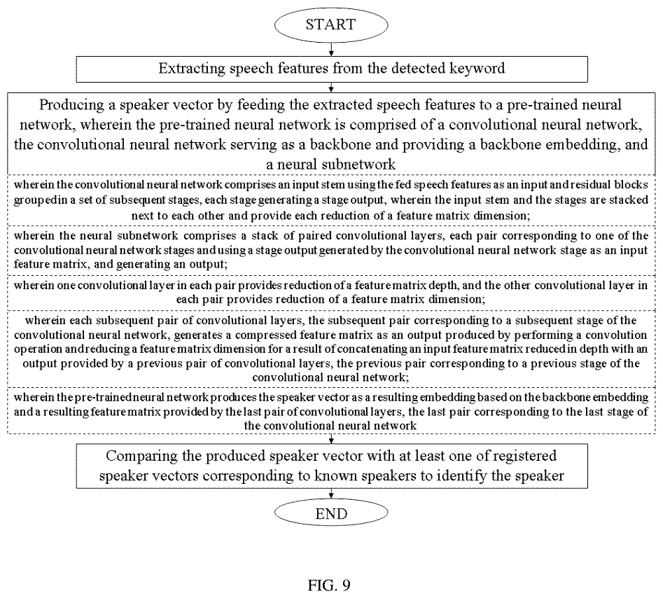

FIG. 9 illustrates a flow diagram of a method of identifying a speaker according to a fourth aspect of the present invention.

The method of FIG. 9 is implemented by the above the speech-processing device 100 according to the second aspect of the present invention. Anyway, the method of FIG. 9 may be implemented by any computing or electronic device known in the art, in particular by a processing unit of the above-mentioned general-purpose computer.

The method of FIG. 9 comprises the following stages or steps:
(1) extracting speech features from at least one keyword;
(2) producing a speaker vector by feeding the extracted speech features to a pre-trained neural network;
   wherein the pre-trained neural network is comprised of a convolutional neural network, the convolutional neural network serving as a backbone and providing a backbone embedding, and a neural subnetwork;
   wherein the convolutional neural network comprises an input stem using the fed speech features as an input and residual blocks grouped in a set of subsequent stages, each stage generating a stage output, wherein the input stem and the stages are stacked next to each other and provide each reduction of a feature matrix dimension;
   wherein the neural subnetwork comprises a stack of paired convolutional layers, each pair corresponding to one of the convolutional neural network stages and using a stage output generated by the convolutional neural network stage as an input feature matrix, and generating an output;
   wherein one convolutional layer in each pair provides reduction of a feature matrix depth, and the other convolutional layer in each pair provides reduction of a feature matrix dimension;
   wherein each subsequent pair of convolutional layers, the subsequent pair corresponding to a subsequent stage of the convolutional neural network, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous stage of the convolutional neural network;
   wherein the pre-trained neural network produces the speaker vector as a resulting embedding based on the backbone embedding and a resulting feature matrix provided by the last pair of convolutional layers, the last pair corresponding to the last stage of the convolutional neural network; and
(3) comparing the produced speaker vector with at least one of registered speaker vectors corresponding to known speakers to identify the speaker.

It will be apparent to one of skill in the art that described herein is a novel system method and apparatus for free keystroke biometric authentication. While the invention has been described with reference to specific preferred embodiments, it is not limited to these embodiments. The invention may be modified or varied in many ways and such modifications and variations, as would be obvious to one of skill in the art, are within the scope and spirit of the invention and are included within the scope of the following claims.

We claim:

1. A method of identifying a speaker, the method being executed on a computing device, comprising:
extracting speech features from at least one keyword;
producing a speaker vector by feeding the extracted speech features to a pre-trained neural network;
wherein the pre-trained neural network is comprised of a convolutional neural network, the convolutional neural network serving as a backbone and providing a backbone embedding, and a neural subnetwork;
wherein the convolutional neural network comprises an input stem using the fed speech features as an input and residual blocks grouped in a set of subsequent stages, wherein the input stem and the stages are stacked next to each other to define residual network levels, each level providing reduction of a feature matrix dimension and generating a level output;
wherein the neural subnetwork comprises a stack of paired convolutional layers, each pair corresponding to one of the residual network levels and using a level output generated by the residual network level as an input feature matrix, and generating an output;
wherein one convolutional layer in each pair provides reduction of a feature matrix depth, and the other convolutional layer in each pair provides reduction of a feature matrix dimension;
wherein each subsequent pair of convolutional layers, the subsequent pair corresponding to a subsequent residual network level, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous residual network level;
wherein the pre-trained neural network produces the speaker vector as a resulting embedding based on the backbone embedding and a resulting feature matrix provided by the last pair of convolutional layers, the last pair corresponding to the last residual network level; and
comparing the produced speaker vector with at least one of registered speaker vectors corresponding to known speakers to identify the speaker.

2. The method of claim 1, wherein the neural subnetwork further comprises a pooling layer and a dense layer, and the resulting embedding generated by the pre-trained neural network is produced by concatenating the backbone embedding with a result of processing the resulting feature matrix with the pooling and dense layers.

3. A method of identifying a speaker, the method being executed on a computing device, comprising:
extracting speech features from at least one keyword;
producing a speaker vector by feeding the extracted speech features to a pre-trained neural network;
wherein the pre-trained neural network is comprised of a convolutional neural network, the convolutional neural network serving as a backbone and providing a backbone embedding, and a neural subnetwork;
wherein the convolutional neural network comprises an input stem using the fed speech features as an input and residual blocks grouped in a set of subsequent stages, each stage generating a stage output, wherein the input stem and the stages are stacked next to each other and provide each reduction of a feature matrix dimension;
wherein the neural subnetwork comprises a stack of paired convolutional layers, each pair corresponding to one of the convolutional neural network stages and using a stage output generated by the convolutional neural network stage as an input feature matrix, and generating an output;
wherein one convolutional layer in each pair provides reduction of a feature matrix depth, and the other convolutional layer in each pair provides reduction of a feature matrix dimension;
wherein each subsequent pair of convolutional layers, the subsequent pair corresponding to a subsequent stage of the convolutional neural network, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous stage of the convolutional neural network;
wherein the pre-trained neural network produces the speaker vector as a resulting embedding based on the backbone embedding and a resulting feature matrix provided by the last pair of convolutional layers, the last pair corresponding to the last stage of the convolutional neural network; and
comparing the produced speaker vector with at least one of registered speaker vectors corresponding to known speakers to identify the speaker.

4. The method of claim 3, wherein the neural subnetwork further comprises a pooling layer and a dense layer, and the resulting embedding generated by the pre-trained neural network is produced by concatenating the backbone embedding with a result of processing the resulting feature matrix with the pooling and dense layers.

5. A speech-processing device for identifying a speaker, the device comprising:
a communication module for receiving or capturing a speech signal corresponding to the speaker; and
a speaker-identification module connected to the communication module to receive the speech signal therefrom and performing at least the following operations:
detecting at least one keyword in the speech signal;
extracting speech features from at least one keyword;
producing a speaker vector by feeding the extracted speech features to a pre-trained neural network;
wherein the pre-trained neural network is comprised of a convolutional neural network, the convolutional neural network serving as a backbone and providing a backbone embedding, and a neural subnetwork;
wherein the convolutional neural network comprises an input stem using the fed speech features as an input and residual blocks grouped in a set of subsequent stages, wherein the input stem and the stages are stacked next to each other to define residual network levels, each level providing reduction of a feature matrix dimension and generating a level output;
wherein the neural subnetwork comprises a stack of paired convolutional layers, each pair corresponding to one of the residual network levels and using a level output generated by the residual network level as an input feature matrix, and generating an output;
wherein one convolutional layer in each pair provides reduction of a feature matrix depth, and the other convolutional layer in each pair provides reduction of a feature matrix dimension;
wherein each subsequent pair of convolutional layers, the subsequent pair corresponding to a subsequent residual network level, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous residual network level;
wherein the pre-trained neural network produces the speaker vector as a resulting embedding based on the backbone embedding and a resulting feature matrix provided by the last pair of convolutional layers, the last pair corresponding to the last residual network level; and
comparing the produced speaker vector with at least one of registered speaker vectors corresponding to known speakers to identify the speaker.

6. A speech-processing device for identifying a speaker, the device comprising:
a communication module for receiving or capturing a speech signal corresponding to the speaker; and
a speaker-identification module connected to the communication module to receive the speech signal therefrom and performing at least the following operations:
detecting at least one keyword in the speech signal;
extracting speech features from at least one keyword;
producing a speaker vector by feeding the extracted speech features to a pre-trained neural network;
wherein the pre-trained neural network is comprised of a convolutional neural network, the convolutional neural network serving as a backbone and providing a backbone embedding, and a neural subnetwork;
wherein the convolutional neural network comprises an input stem using the fed speech features as an input and residual blocks grouped in a set of subsequent stages, each stage generating a stage output, wherein the input stem and the stages are stacked next to each other and provide each reduction of a feature matrix dimension;
wherein the neural subnetwork comprises a stack of paired convolutional layers, each pair corresponding to one of the convolutional neural network stages and using a stage output generated by the convolutional neural network stage as an input feature matrix, and generating an output;
wherein one convolutional layer in each pair provides reduction of a feature matrix depth, and the other convolutional layer in each pair provides reduction of a feature matrix dimension;
wherein each subsequent pair of convolutional layers, the subsequent pair corresponding to a subsequent stage of the convolutional neural network, generates a compressed feature matrix as an output produced by performing a convolution operation and reducing a feature matrix dimension for a result of concatenating an input feature matrix reduced in depth with an output provided by a previous pair of convolutional layers, the previous pair corresponding to a previous stage of the convolutional neural network;
wherein the pre-trained neural network produces the speaker vector as a resulting embedding based on the backbone embedding and a resulting feature matrix provided by the last pair of convolutional layers, the last pair corresponding to the last stage of the convolutional neural network; and
comparing the produced speaker vector with at least one of registered speaker vectors corresponding to known speakers to identify the speaker.
